(19) United States
(12) Patent Application Publication
(10) Pub. No.: US 2005/0194405 A1
(43) Pub. Date: Sep. 8, 2005

(54) Bulk bag handling apparatus and method

(76) Inventor: Mark Michael Kosich, Bailey, NC (US)

Correspondence Address: Mark Michael Kosich, 7739 Old Raleigh Road, Bailey, NC, 27807, US

(21) Appl. No.: 10/791,520

(22) Filed: Mar. 2, 2004

(51) Int. Cl. B67D 5/06

(52) U.S. Cl. 222/181.1

(57) ABSTRACT

A method and apparatus for handing and discharging bulk bags includes positioning an adapter assembly on a flexible bulk bag having a spout, inverting the bulk bag, and selectively discharging the contents. The adapter includes a rigid annular adapter ring with an annular, radially-outwardly extending flange adapted for being engaged by a surrounding clamp, The bulk bag is secured to the adapter ring by folding the edge of the spout opening over the flange and clamping the edge to the flange. With the adapter assembly installed a bulk bag may be manipulated in the same manner as a rigid drum.

### BACKGROUND OF THE INVENTION

This invention relates generally to bulk bag handing equipment and more particularly to a bulk bag discharging device which allows the discharge of bulk material from a storage bag.

Bulk bags are widely used to store powders such for making chemicals, food products, pharmaceuticals, cosmetics, plastics and many other items. These types of bags are often called flexible intermediate bulk containers. Bulk bags are typically made of woven polypropylene fabric panels sewn in a cube shape, and may contain from 230 kg (500 lbs.) to 2000 kg (4500 lbs.) of bulk material.

The design of prior art bulk bag discharging equipment is limited because bulk bag handling is presently done by only one basic method. Prior art bulk bags in which powder products are packaged are made with an upper inlet spout for filling and a lower outlet spout for discharging. This means that bulk bags must be filled through the top, shipped with the outlet on the bottom and then lifted onto a framework to support the bulk bag. An operator reaches underneath the bulk bag, then connects the outlet spout to a chute that is connected to a metering or conveying device. Present method dischargers, usually standing between 12 to 15 feet tall, occupy a large volume of space and deliver the product to floor level. To bring the product up to a height where it can be delivered into a process inlet requires either a very high ceiling, or the use of conveyors, which consume a significant amount of horizontal space. Furthermore, conventional bulk bag discharging equipment does not allow for the same speed of changeover and ease of accurate metering as other types of containers.

Accordingly, there is a need for a bulk bag handling system which provides easy handling and consumes a minimum of space.

### BRIEF SUMMARY OF THE INVENTION

Therefore, it is an object of the invention to provide a bulk bag which may be discharged with a low ceiling height.

It is another object of the invention to provide an adapter assembly which allows a bulk bag to be handled in the same manner as a rigid drum.

It is another object of the invention to provide a bulk bag having reduced weight and cost and improved flow capabilities.

It is another object of the invention to provide a method for selectively discharging material from a bulk bag.

It is another object of the invention to provide a method for manipulating bulk bags.

These and other objects of the present invention are achieved in the preferred embodiments disclosed below by providing an adapter assembly for being mounted to a flexible bulk bag having a body, and a spout with an opening for discharging bulk material therefrom, The adapter assembly includes a rigid annular adapter ring including an annular, radially-outwardly extending flange adapted for being engaged by a surrounding clamp and means for supporting the spout of the bulk bag.

According to another embodiment of the invention, the support means include at least one arm extending away from the adapter ring, The arm adapted to engage the bulk bag.

According to another embodiment of the invention, a discharge device is adapted to be attached to the adapter ring.

According to another embodiment of the invention, the discharge device is a funnel valve having an inlet end for being attached to the flange and an outlet including a valve for stopping and starting a flow of material.

According to another embodiment of the invention, the discharge device is a cone valve, including a tapered funnel having an inlet end with a first diameter for being attached to the flange, and an outlet end having a second diameter smaller than the first diameter. A cone is disposed in the funnel, the base of the cone facing the outlet end. The cone is movable between a closed position in which a peripheral edge thereof of the cone seals against the funnel, and an open position in which material may flow between the peripheral edge and the funnel.

According to another embodiment of the invention, the discharge device is a split butterfly valve, comprising a passive valve section including a passive valve disk movable between a closed position and an open position; and an active valve section removable connected to the passive valve section, the active valve section including an active valve disk movable between a closed position and an open position. The passive valve disk is locked into the closed position when the active valve section is disconnected from the passive valve section.

According to another embodiment of the invention, An apparatus for storing and discharging bulk material includes a flexible bulk bag for containing a flowable material, the bulk bag having a spout with an opening, and an adapter assembly attached to the bag, which includes a rigid annular adapter ring including an annular protruding flange and means for supporting the spout of the bulk bag in. A discharge device is attached to the adapter assembly for guiding material out of the bulk bag.

According to another embodiment of the invention, An apparatus for supporting a flexible bulk bag having a body and a spout with an opening for discharging bulk material therefrom, includes an adapter assembly for being attached to the bag. The adapter assembly includes a rigid annular adapter ring including an annular, radially-outwardly extending flange adapted for being engaged by a surrounding clamp, and means for supporting the spout of the bulk bag. At least one support bracket is adapted to be attached to the bulk bag and the adapter assembly. The support bracket cooperates with the adapter assembly to support the bulk bag in a tensioned condition.

According to another embodiment of the invention, the support bracket comprises a pair of spaced-apart vertical members bridged by a pair of generally C-shaped horizontally extending braces.

According to another embodiment of the invention, the support bracket includes at least one bag mount for receiving a mounting means carried by the bulk bag.

According to another embodiment of the invention, the bag mount is a cleat having a pair of pivoted jaws.

According to another embodiment of the invention, the adapter assembly and the support bracket include complementary alignment features for maintaining the adapter assembly in a fixed position relative to the support bracket.

According to another embodiment of the invention, a method for discharging material from a bulk bag having a spout with an outlet includes the steps of: disposing the bag with the spout facing upwards; placing an adapter assembly on the bulk bag, the adapter assembly supporting the outlet in a rigid open shape; attaching a discharge device to the outlet inverting the bulk bag; and allowing material to flow from the bulk bag through the outlet and the discharge device.

According to another embodiment of the invention, the step of placing the adapter assembly on the bulk bag comprises inserting the opening of the spout through the adapter ring; folding the edge of the opening over the flange; and clamping the edge of the bag against the flange.

According to another embodiment of the invention, the step of allowing material to flow from the bulk bag through the outlet and the discharge device includes selectively starting and stopping the flow of material through the discharge device.

According to another embodiment of the invention, subsequent to the step of attaching an adapter assembly to the bulk bag, at least one support bracket is attached to the bulk bag and to the adapter assembly such that the bulk bag is supported in a tensioned condition.

According to another embodiment of the invention, the step of attaching a support bracket to the bulk bag and to the adapter assembly includes positioning a pair of said support brackets on opposite sides of the bulk bag.

According to another embodiment of the invention, the method further includes providing the bulk bag with mounting means, providing the support bracket with at least one bag mount, and attaching the mounting means to the bag mount.

The present invention and its advantages over the prior art will become apparent upon reading the following detailed description and the appended claims with reference to the accompanying drawings.

### BRIEF DESCRIPTION OF THE DRAWINGS

The invention may be best understood by reference to the following description taken in conjunction with the accompanying drawing figures in which:

FIG. 1 is a side view of an exemplary bulk bag discharging assembly constructed in accordance with the present invention;

FIG. 2 is a side view of a bulk bag for use with the present invention;

FIG. 3 is a side view of a bulk bag for use with the present invention;

FIG. 4 is a side view of an adapter assembly for a bulk bag;

FIG. 5 is a bottom view of the adapter assembly of FIG. 4;

FIG. 6 is a partial side view of a bulk bag attached to an adapter assembly;

FIG. 7 is a schematic side view of a bulk bag being moved using a forklift with a bale clamp;

FIG. 8 is a schematic side view of a bulk bag being discharged using a forklift with a bale clamp;

FIG. 9 is a side view of a funnel module discharge device;

FIG. 10 is a bottom view of the funnel module of FIG. 9;

FIG. 11 is a side view of an adapter assembly incorporating a split butterfly valve module;

FIG. 12 is a side view of a cone valve discharge device;

FIG. 13 is a side cross-sectional view of an alternative embodiment of a cone valve module;

FIG. 14 is another view of the cone valve module shown in FIG. 13;

FIG. 15 is a side view of another embodiment of a cone valve module;

FIG. 16 is a side view of an alternative adapter assembly;

FIG. 17 is an end view of the adapter assembly of FIG. 16;

FIG. 18 is a perspective view of another alternative adapter assembly;

FIG. 19 is a top view of a bag clamp constructed in accordance with the present invention;

FIG. 20 is a front view of bag clamp constructed in accordance with the present invention;

FIG. 21 is a side view of a bulk bag being lifted by a column lift;

FIG. 22 is a side view of the bulk bag of FIG. 21 being placed on a discharge frame;

FIG. 23 is a schematic overhead view of a floor rail bulk bag handling system;

FIG. 24 is a side view of a harness assembly for lifting bulk bags;

FIG. 25 is a side view of a harness assembly and an overhead hoist;

FIG. 26 is another view of the harness assembly and overhead hoist of FIG. 25;

FIG. 27 is a side view of a harness assembly for lifting bulk bags with a vacuum lift;

FIG. 28 is a partial cut-away view of a disk feeder;

FIG. 29 is an exploded view of the disk feeder of FIG. 28;

FIG. 30 is an exploded view of an alternative housing for the disk feeder of FIG. 28;

FIG. 31 is a view taken along lines 31-31 of FIG. 29;

FIG. 32 is a view taken along lines 32-32 of FIG. 29;

FIG. 33 is a side view of a discharge station incorporating a drive motor for a discharge device;

FIG. 34 is a side view of a discharge station incorporating a lost-weight discharging system;

FIG. 35 is a side view of a tensioning apparatus for use with the present invention;

FIG. 36 is a view of a tensioning device;

FIG. 37 is a view of the tensioning device of FIG. 36 in a deflected position;

FIG. 38 is a view of an alternative tensioning device;

FIG. 39 is a view of an end attachment for the tensioning device of FIG. 38;

FIG. 40 is a side view of a discharge station incorporating a tensioning device;

FIG. 41 is a side view of a two-spout bag constructed in accordance with the present invention;

FIG. 42 is a side view of a portable bin incorporating a bulk bag therein;

FIG. 43 is a side view of a bag for use in making a bag drum in accordance with the present invention;

FIG. 44 is a side view of a bag drum according to the present invention;

FIG. 45 is a side view of a bulk bag filling apparatus according to the present invention;

FIG. 46 is another view of the filling apparatus of FIG. 45;

FIG. 47A is a partial side view of a bulk bag including a mounting strap;

FIG. 47B is a partial side view of a bulk bag including a mounting rope;

FIG. 47C is a partial side view of a bulk bag including a mounting strap with a snap hook;

FIG. 47D is a partial side view of a bulk bag including an eyelet;

FIG. 47E is a partial side view of a bulk bag including an mounting loop;

FIG. 48 is a side view of a bulk bag mounted in an alternative adapter assembly and support brackets;

FIG. 49 is a front view of the bulk bag of FIG. 49;

FIG. 50 is an end view of the adapter assembly of FIG. 49;

FIG. 51 is a side view of a support bracket constructed in accordance with the present invention;

FIG. 52 is a top view of the support bracket of FIG. 51;

FIG. 53 is a front view of the support bracket of FIG. 51;

FIG. 54 is an exploded side view showing the assembly of a pair of support brackets to a bulk bag;

FIG. 55 is a side view of a bulk bag mounted in another alternative adapter assembly and support brackets;

FIG. 56 is a front view of the bulk bag and support brackets of FIG. 55;

FIG. 57 is a side view of a bulk bag mounted in another alternative adapter assembly and support brackets;

FIG. 58 is a front view of the bulk bag and support brackets of FIG. 57;

FIG. 59 is an end view of an alternative bag clamp in position to engage a bulk bag and adapter assembly;

FIG. 60 is a schematic side view of a discharge station including a screw feed drive unit;

FIG. 61 is a schematic side view of an alternative adapter assembly and support frame;

FIG. 62 is a side view of a support bracket having a plurality of mounting hooks attached thereto;

FIG. 63 is a top view of the support bracket of FIG. 62;

FIG. 64 is a front view of the support bracket of FIG. 62;

FIG. 65 is a front view of a pair of fork adapters constructed in accordance with the present invention;

FIG. 66 is a top view of the fork adapter of FIG. 65;

FIG. 67 is a side view of a bulk bag mounted in an alternative adapter assembly and support brackets;

FIG. 68 is a front view of the bulk bag of FIG. 67;

FIG. 69 is an exploded side view showing the assembly of a pair of support brackets to a bulk bag;

FIG. 70 is a side view of a bulk bag filling apparatus according to the present invention;

FIG. 71 is a top view of an alternative bulk bag constructed according to the present invention;

FIG. 72 is a side view of the bulk bag of FIG. 71;

FIG. 73 is a side view of a pair of stacked bulk bags;

FIG. 74 is a top view of a turning fork assembly for use with the present invention;

FIG. 75 is a front view of the turning fork assembly of FIG. 74;

FIG. 76 is a side view of a bulk bag having an offset spout;

FIG. 77 is a side view of a box dumper adapted for use with the present invention;

FIG. 78 is a top view of a pair of alternative support brackets for a bulk bag;

FIG. 79 is a front view of the support brackets of FIG. 78;

FIG. 80 is a side view of a pair of support brackets incorporating a bag clamp;

FIG. 81 is a front view of the support brackets of FIG. 80 with the bag clamp in an open position;

FIG. 82 is a front view of the support brackets of FIG. 81 with the bag clamp in a closed position;

FIG. 83 is a front view of a variation of a pair of support brackets incorporating a spring-biased bag clamp;

FIG. 84 is a front view of another variation of a pair of support brackets incorporating a bag clamp biased by air springs; and

FIG. 85 is a schematic side view of an alternative bag filling apparatus.

### DETAILED DESCRIPTION OF THE INVENTION

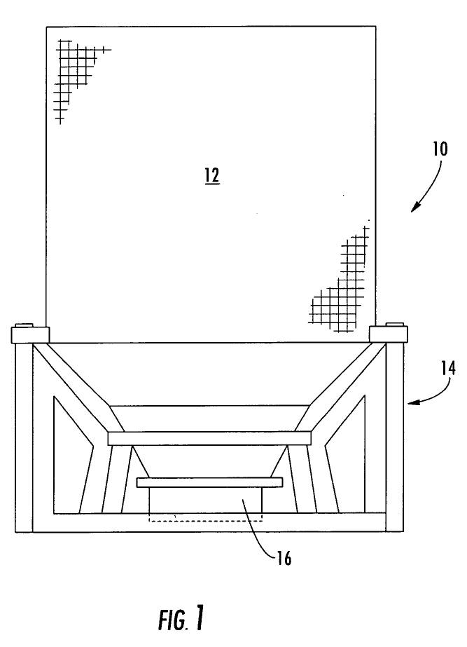

Referring to the drawings wherein identical reference numerals denote the same elements throughout the various views, FIG. 1 depicts a bulk bag discharge assembly 10 constructed in accordance with the present invention. The bulk bag discharge assembly 10 includes a bulk bag 12, an adapter assembly 14, and a discharge device 16. The adapter assembly 14, described in more detail below, provides the bulk bag 12 with a rigid opening and tensions the top of the bulk bag 12. This enables the bulk bag 12 to be easily manipulated and inverted, and provides a convenient surface for engaging the discharge device 16. This allows a flexible bulk bag 12 to be handled in much the same way as a conventional rigid drum.

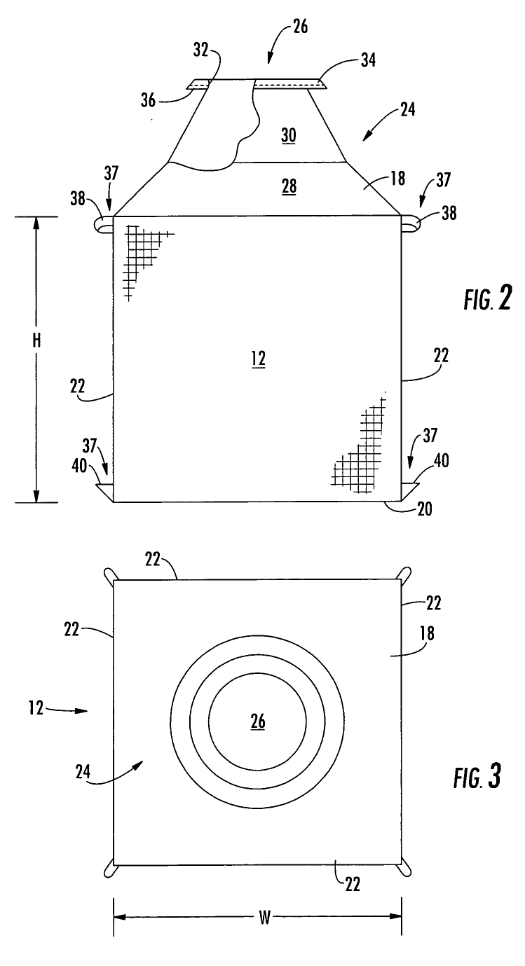

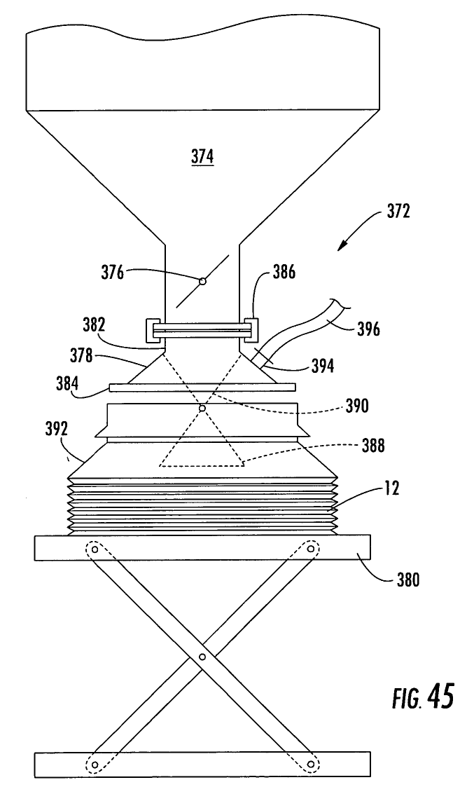

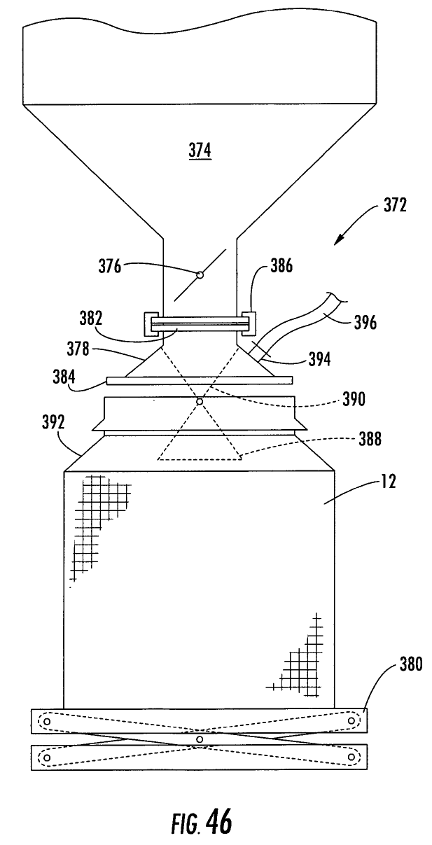

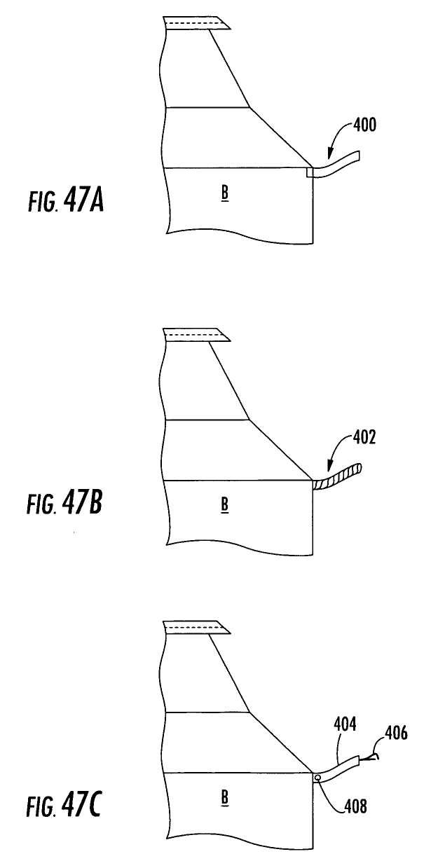

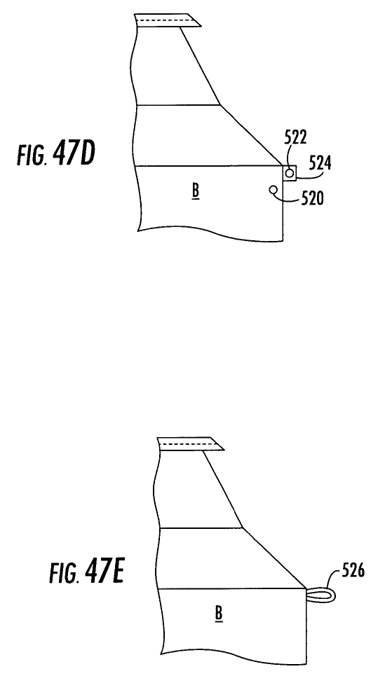

FIGS. 2 and 3 illustrate a bulk bag 12 for use with the present invention. The bulk bag 12 is a cubic or rectangular envelope having a top panel 18, a lower panel 20, and a plurality of side panels 22. The bulk bag 12 may be made from any strong, flexible material. One suitable material comprises woven polypropylene fabric. The bulk bag 12 may be fabricated by sewing individual panels together. The dimensions of the bulk bag 12 may be varied to suit a particular application, however in common applications the capacity of the bulk bag 12 is typically from about 230 kg (500 lbs.) to about 2000 kg (4500 lbs.) In the illustrated example, the bulk bag 12 has a width W of about 91 cm (36 in.), and a height H of about 107 cm (42 in.) The top panel 18 of the bulk bag 12 is formed into a tapered spout 24. The spout 24 gradually transitions from the square shape of the bulk bag 12 to a circular outlet 26. In this particular example the spout 24 has a first taper 28 of about 45° and a second taper 30 of about 60°. This dual-tapered shape has been found to facilitate the discharge of material from the bulk bag 12. However, the taper of the spout 24 may be changed to suit a particular application. The spout 24 could also be a straight-sided cylindrical structure. The outlet 26 comprises a short cylindrical section 32 and an optional circumferential flap 34. The flap 34 may include a reinforcement ring 36, such as a section of doubled-over fabric or nylon webbing stitched to the edge of the flap 34. The bulk bag 12 includes a plurality of mounting means 37 attached thereto. In the particular example illustrated, a plurality of loops 38 formed from straps of material affixed to the bulk bag 12 near the juncture of the body of the bulk bag 12 and the spout 24, and a plurality of pockets 40 are attached to the bulk bag 12 near the bottom end. The loops 38 and pockets 40 are used to mount the bulk bag 12 and to tension it, as described in more detail below. As shown in FIGS. 47A-47E, the mounting means may comprise a number of different structures so long at it allows a bulk bag (labeled generically as “B” in FIGS. 47A-47E) to be attached to a supporting structure. Examples of suitable mounting means include a plain strap 400 made of webbing, a rope 402, or a strap 404 with a snap hook 406 and eyelet 408. The mounting means could also comprise an eyelet 520 attached directly to the bulk bag 12, an eyelet 532 disposed in a flexible tab 524 attached to the bulk bag 12, or a loop 526 made of rope or flat webbing.

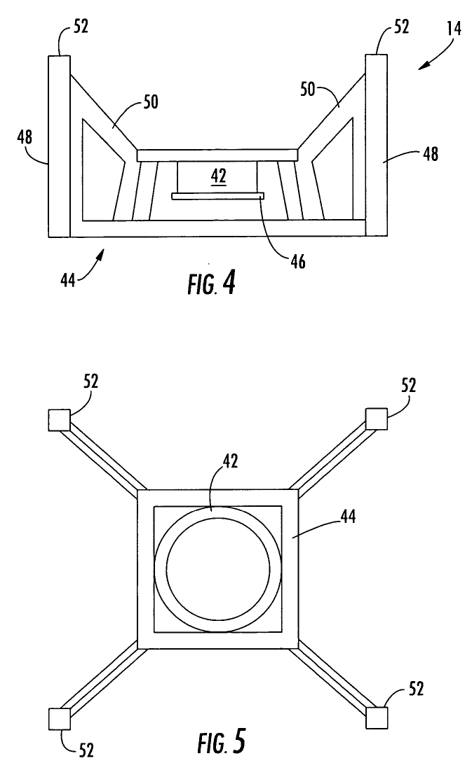

FIGS. 4 and 5 illustrate an exemplary adapter assembly 14. The adapter assembly 14 includes an adapter ring 42 and bag support means comprising a support frame 44. The adapter ring 42 is a short cylindrical member having an annular, radially-outwardly extending flange 46 disposed at its upper peripheral edge. The flange 46 may take a number of forms, but preferably is it a circular-section bead similar to that of the top ring of conventional storage drum. The support frame 44 is attached to the adapter ring 42, In this example, the support frame 44 comprises four radially-extending arms 48. The upper tubes 50 of the arms 48 extend away from the adapter ring 42 at approximately a 45° angle. The support frame 44 includes tensioning means for holding the spout 24 of the bulk bag 12 in a stretched-out condition as shown in FIG. 1, so that the bulk material can flow freely out of the bulk bag 12 when it is inverted. In the illustrated example, the tensioning means comprises vertically-extending posts 52 which hold the loops 38 of the bulk bag 12, as shown in FIG. 1.

The adapter assembly 14 may be constructed of any material which will support the expected weight of the bulk bag 12. For example, the adapter assembly 14 may be fabricated from welded steel. However, it is desirable to make the adapter assembly 14 as lightweight as possible. This allows the adapter assembly 14 to be placed on to a bulk bag 12 manually. Furthermore, the adapter assembly 14 should be as inexpensive as possible so that a large quantity of adapter assemblies 14 may be kept on hand and pre-staged on bulk bags 12. This avoids the need to install an adapter assembly 14 each time a bulk bag 12 is to be emptied. Accordingly, the adapter assembly 14 may be made from other materials, such as aluminum, titanium, or plastic.

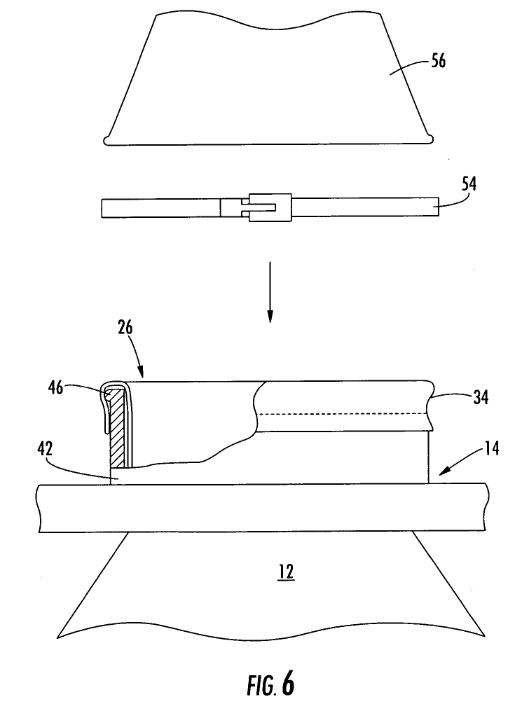

FIG. 6 shows how the adapter assembly 14 is attached to a bulk bag 12. When the bulk bag 12 is in an upright position with the spout 24 facing up, the adapter assembly 14 in placed on top of the bulk bag 12. The outlet 26 is opened and then pulled up through the center of the adapter ring 42. The flap 34 is folded outward and down over the flange 46 and the against the side of the adapter ring 42. The flap 34 is then clamped against the adapter ring 42, for example using a drum ring clamp 54 of a known type. The drum ring clamp 54 may also be used to attach a discharge device to the adapter ring 42, such as the illustrated funnel 56. Once the bulk bag 12 is clamped in place, it may be inverted to discharge its contents. A drum lid of a known type (not shown) could also be attached to the adapter ring 42 in order to store the bulk bag 12 before discharging it, or to close off a partially discharged bulk bag 12 with the adapter assembly 14 still attached.

The adapter assembly may take a number of different forms, so long as it includes a means for supporting the spout 24 of the bulk bag 12 and for providing a connection to whatever discharging equipment is being used. FIGS. 16 and 17 illustrate an alternative adapter assembly 120. The adapter assembly 120 includes an adapter ring 122 which is a short cylindrical member having an annular, radially-outwardly extending flange 124 disposed at its peripheral edge. The flange 124 may take a number of forms, but preferably is it a circular-section bead similar to that of the top ring of conventional storage drum. A hollow transition section 126 comprising a generally tapered member is attached to the adapter ring 122. In this example the transition section 126 has a conical form adjacent the adapter ring 122 which blends into a four-sided pyramidal shape at the opposite end. Other shapes, such as a pure cone, could be used. The illustrated example also includes an array of upstanding stub posts 128, which are explained in more detail below.

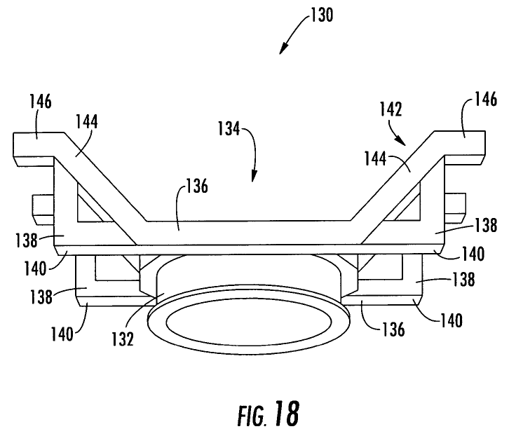

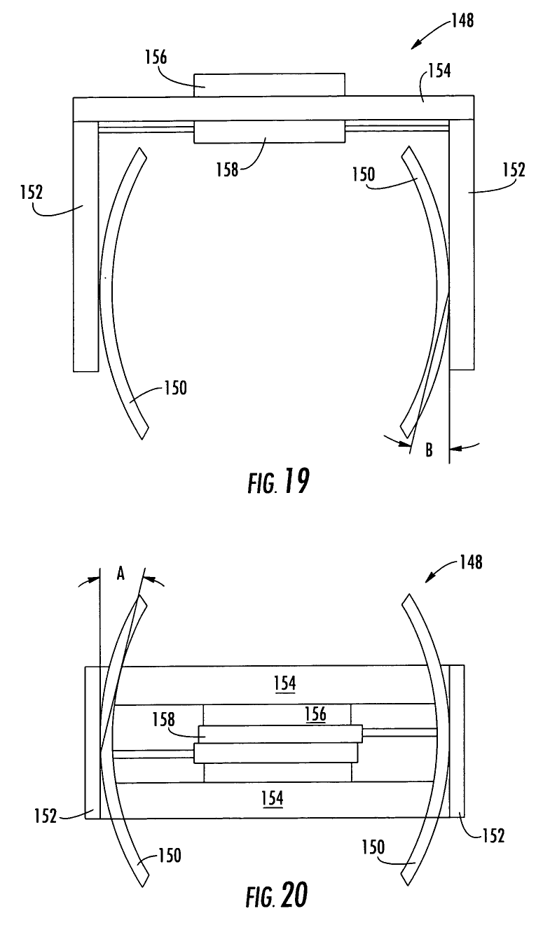

FIG. 18 illustrates yet another alterative adapter assembly 130. The adapter assembly 130 includes an adapter ring 132 identical to those described above, as well as a support frame 134. The support frame 134 is built up from a number of box-section members, or it could also be stamped or molded in the appropriate shape. The support frame 134 includes a pair of spaced-apart rails 136. A plurality of brackets 138 are attached to the rails 136 and define a plurality of lower support surfaces 140. These lower support surfaces 140 may be used to place the adapter assembly 130 on a flat surface or other supporting structure. A plurality of extension posts 142 are attached to the ends of the rails 136. Each of these extension posts 142 includes an angled portion 144 and a horizontal portion 146. The angled portion 144 generally conforms to the shape of an inverted bulk bag 12, while the horizontal portion 146 extends past the bulk bag 12 when it is attached to the adapter assembly 130. These horizontal portions 146 may be used for mounting or tensioning purposes, as described below.

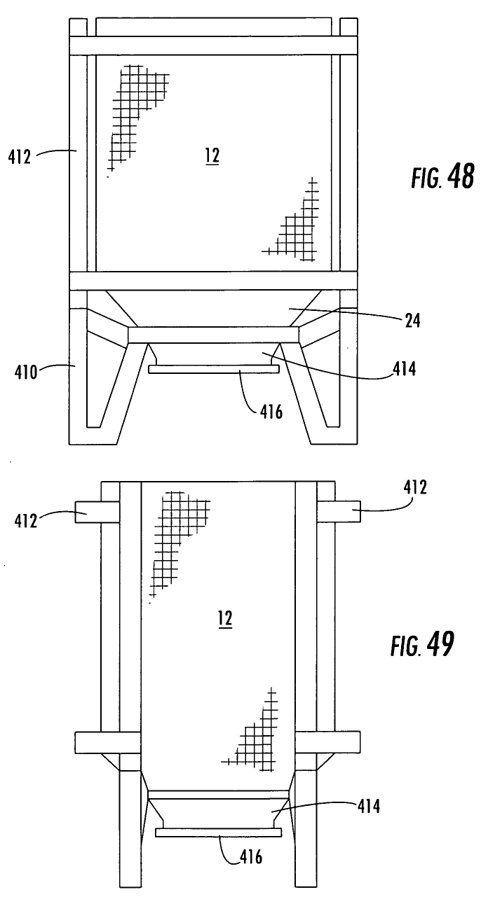

FIGS. 48 and 49 illustrate an alternative apparatus for handing a bulk bag 12 which includes an adapter assembly 410 and a pair of support brackets 412. The adapter assembly 410 is similar in construction to the adapter assembly 14 described above and includes a hollow transition section 414 having an annular, radially-outwardly extending flange 416 disposed at its peripheral edge. The flange 416 may take a number of forms, but preferably is it a circular-section bead similar to that of the top ring of conventional storage drum. The adapter assembly 410 also includes a plurality of angled arms 418 (see FIG. 50). The adapter assembly 410 is attached to the spout 24 of the bulk bag 12 in the manner described above.

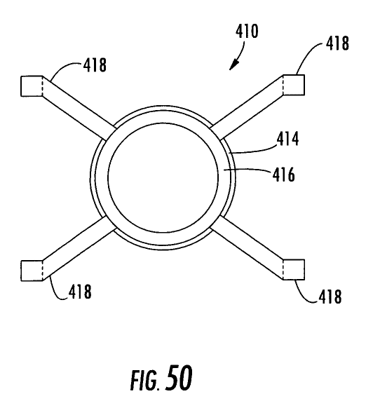

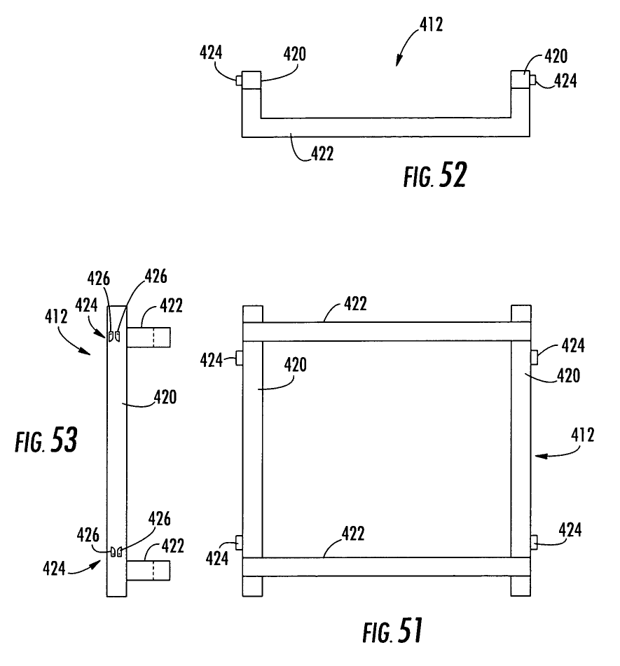

FIGS. 51-53 illustrate the construction of one of the support brackets 412. The support bracket 412 has a pair of vertical members 420 connected by upper and lower C-shaped braces 422. The support bracket 420 may be constructed from metal tubing, wood, plastic, or any other material which is strong enough to absorb the expected loads. The support bracket 412 also includes a plurality of bag mounts 424. The bag mounts 424 receive the mounting means 37 of the bulk bag 12 and allow the bulk bag 12 to be secured to the support bracket 412. In the illustrated example each bag mount 424 comprises a cleat of a known type having a pair of pivoted arcuate jaws 426. A strap or rope (not shown) may be placed in the cleat 424 and pulled tight to secure the bulk bag 12. The strap or rope may be released when desired by pulling it out in a direction perpendicular to the toothed surface of the jaws 426. The bag mounts 424 may be any structure which will allow the mounting means 37 to be removably attached thereto. Examples of suitable structures include hooks, screw eyes, or a simple upstanding post or rod.

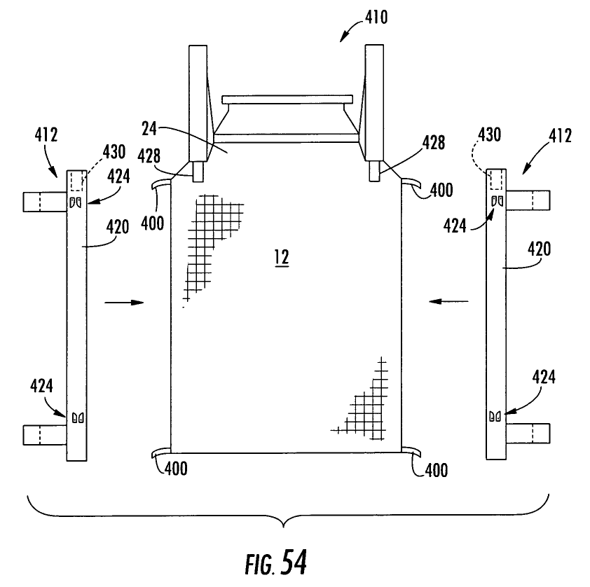

The bulk bag 12 is prepared for use as follows: First, with the bulk bag 12 in the upright position, an adapter assembly 410 is attached to the spout 24 of the bulk bag 12 as described above. Then, a pair of support brackets 412 are brought into the bulk bag 12 from opposite sides, as shown in FIG. 54. The support brackets 412 slide underneath the adapter assembly 410 so that the vertical members 420 extend from the ground to the adapter assembly 410. The adapter assembly 410 and support brackets 412 may include mating alignment features such as the complementary tubular studs 428 and receptacles 430 shown. If necessary, the adapter assembly 410 is lifted upwards as the support brackets 412 are slid into position. Once the support brackets 412 are in place, they are secured to the bulk bag 12 by connecting the mounting means 37 of the bulk bag 12 to the bag mounts of the support brackets 412, for example by tying off the straps 400 of the bulk bag 12 to the bag mounts 424 of the support brackets 412.

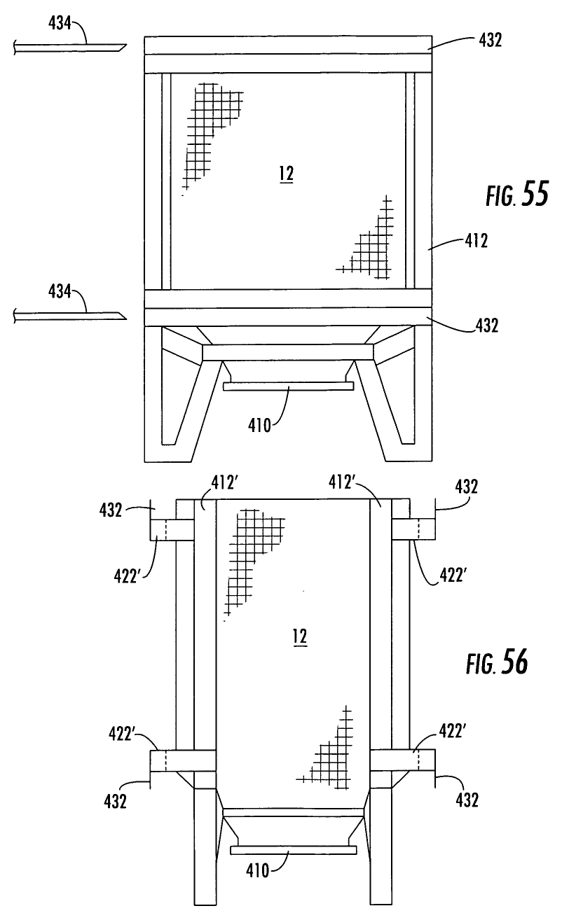

Thus assembled, the bulk bag 12, adapter assembly 410, and support brackets 412 form a unit (shown in FIG. 49) that can be handled much like a rigid container. The presence of the vertical members 420 prevents the bulk bag 12 from slumping as is it emptied. The bulk bag 12 can be clamped by a bale clamp 58 as described below, because the vertical members 420 are offset inwards and do not interfere with the clamp panels. The support brackets 412 can also provide other options for handling the bulk bags 12. For example, as shown in FIGS. 55 and 56, a support bracket 412′ has side plates 432 attached to each of the braces 422′. The side plates 432 act as a guide for receiving the forks 434 of a conventional forklift (not shown) in either a high or low position, so that the bulk bag 12 can be lifted whether upright or inverted. A dual high forks and low forks adapter of a known type (not shown), having a total of four forks, may also be used to lift the bulk bag 12 by engaging the support brackets 412′ in both the high and low positions simultaneously.

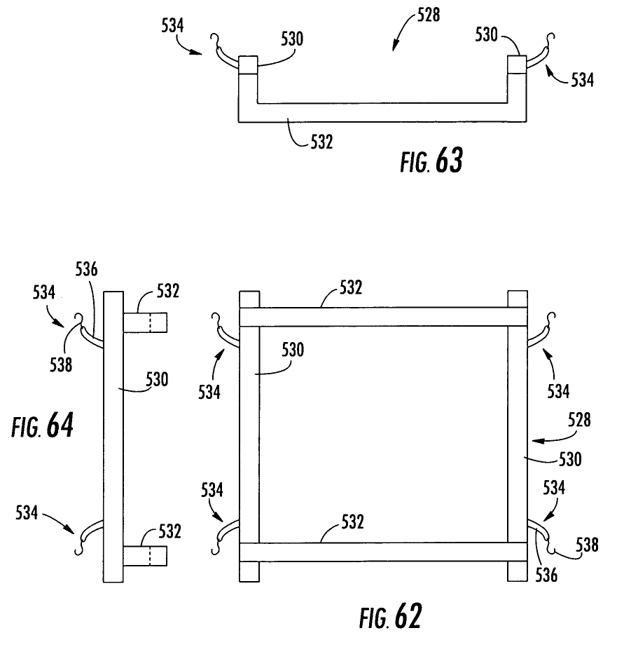

FIGS. 62-64 illustrate an alternative support bracket 528. The support bracket 528 is substantially similar in construction to the support bracket 412 and has a pair of vertical members 530 connected by upper and lower C-shaped braces 532. The support bracket 528 also includes a plurality of bag mounts 534 which receive the mounting means 37 of the bulk bag 12 and allow the bulk bag 12 to be secured to the support bracket 528. In the illustrated example, each of the bag mounts 534 is a flexible member such as a rope, strap, or stretchable cord. In particular, the bag mounts 534 may each comprise an elastic bungee cord 536 having a hook 538 that attaches to the mounting means 37 of the bulk bag 12 (e.g. an eyelet or loop as described above). As noted above, the bag mounts 534 may be any structure which will allow the mounting means 37 to be removably attached thereto.

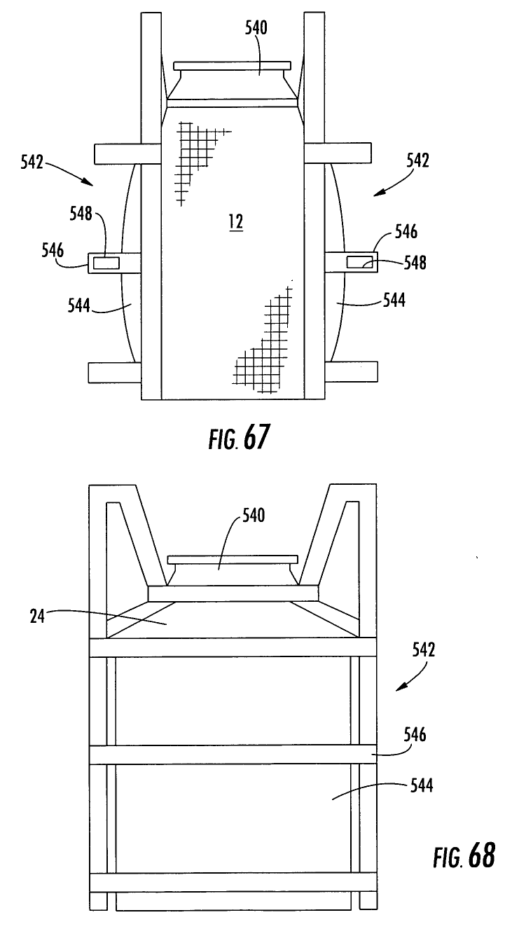

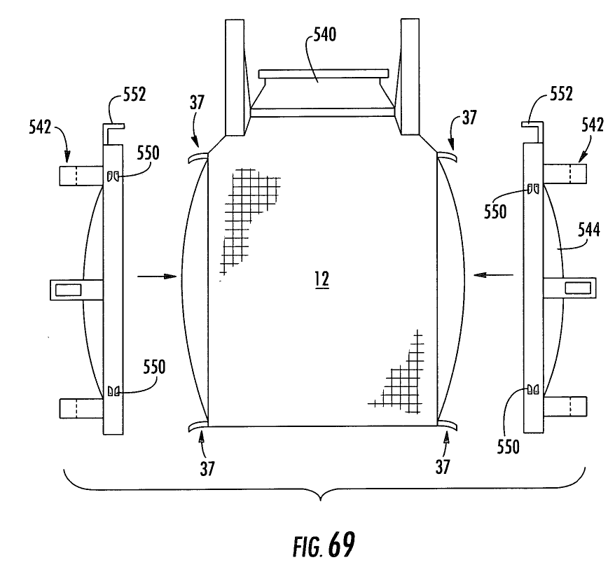

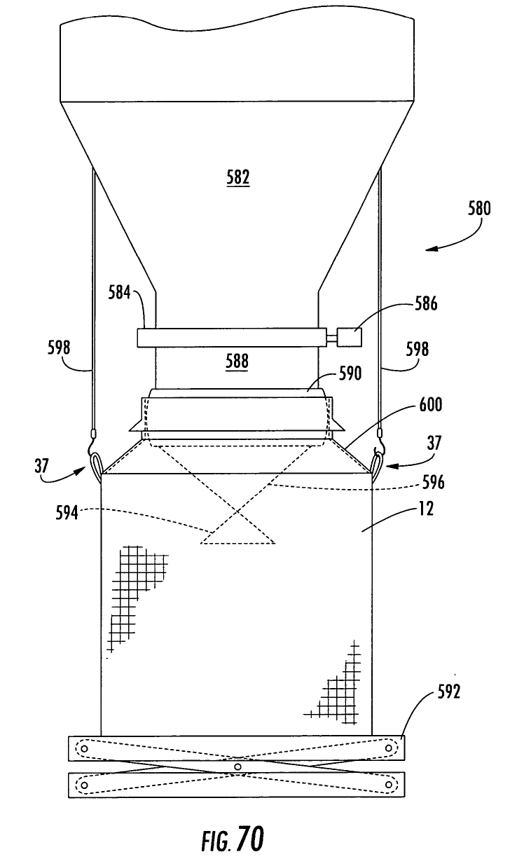

FIGS. 67 and 68 illustrate yet another alternative apparatus for handing a bulk bag 12 which includes an adapter assembly 540 and a pair of support brackets 542. The adapter assembly 540 is similar in construction to the adapter assembly 410 described above. The adapter assembly 540 is attached to the spout 24 of the bulk bag 12 in the manner described above. Each of the support brackets 542 is substantially similar in construction to the support brackets 412 described above. The primary differences between the support bracket 542 and the support bracket 412 are the inclusion of a side panel 544 and a center fork bracket 546 in the support bracket 542. The side panel 544 Is curved in the vertical and horizontal directions to generally conform to the bulged shaped of a filled bulk bag 12. The side panel 544 may be a continuous surface such as a sheet metal panel, or it may be made up of a series of strips or bands. The center fork bracket 546 is mounted at a convenient height and includes a fork slot 548 sized to accept a stander fork of a forklift (not shown). The support bracket 542 also includes a plurality of bag mounts 550 (see FIG. 69) similar to the bag mounts 424 described above which receive the mounting means 37 of the bulk bag 12 and allow the bulk bag 12 to be secured to the support bracket 542.

FIG. 69 illustrates how the adapter assembly 540 and support brackets 542 are attached to the bulk bag 12. First, with the bulk bag 12 in the upright position, the adapter assembly 540 is attached to the spout 24 of the bulk bag 12 as described above. Then, a pair of support brackets 542 are brought into the bulk bag 12 from opposite sides. The support brackets 542 may include hanger channels 552 which engage the adapter assembly 540 to secure it to the support bracket 542 In the vertical direction. The side panels 544 conform to the bulged sides of the filled bulk bag 12 and give support to the bulk bag 12. Thus, no squeezing of the bulk bag 12 takes place. This is especially useful if the bulk bag 12 contains fragile material. Once the support brackets 542 are in place, they are secured to the bulk bag 12 by connecting the mounting means 37 of the bulk bag 12 to the bag mounts 550 carried by the support brackets 412.

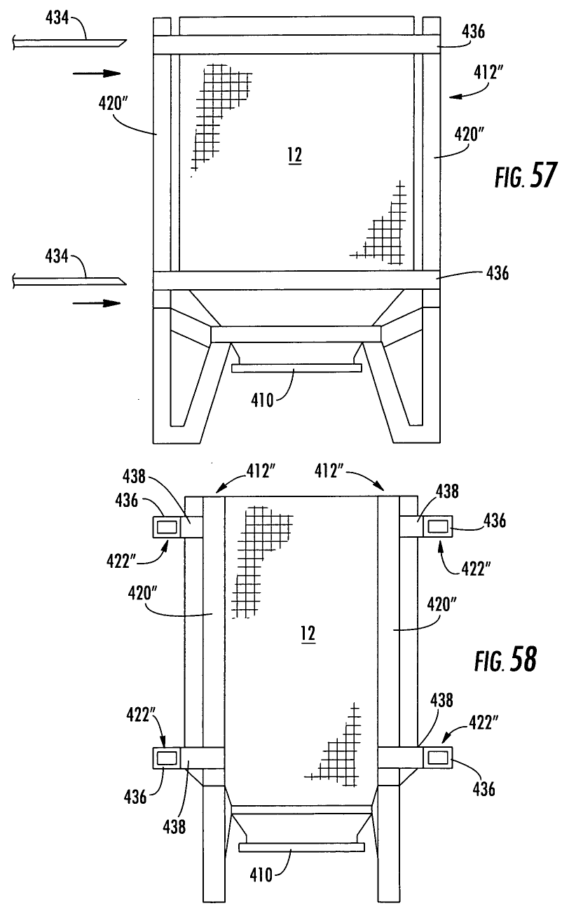

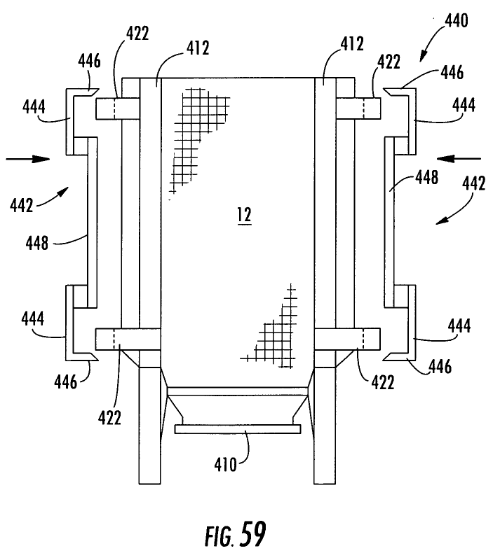

FIGS. 57 and 58 illustrate an alternative support bracket 412″. The support brackets 412″ are substantially similar to those described above, including a pair of vertical members 420″ connected by C-shaped braces 422″. However, in this embodiment, each of the braces 422″ includes an open-ended horizontal member 436 connected to the vertical members 420″ by standoffs 438. The dimensions of the horizontal members 436 are selected to be large enough to accept the forks 434 of a conventional forklift (not shown), in either a high or low position, so that the bulk bag 12 can be lifted whether upright or inverted. A dual high forks and low forks adapter of a known type (not shown), having a total of four forks, may also be used to lift the bulk bag 12 by engaging the support brackets 412′ in both the high and low positions simultaneously.

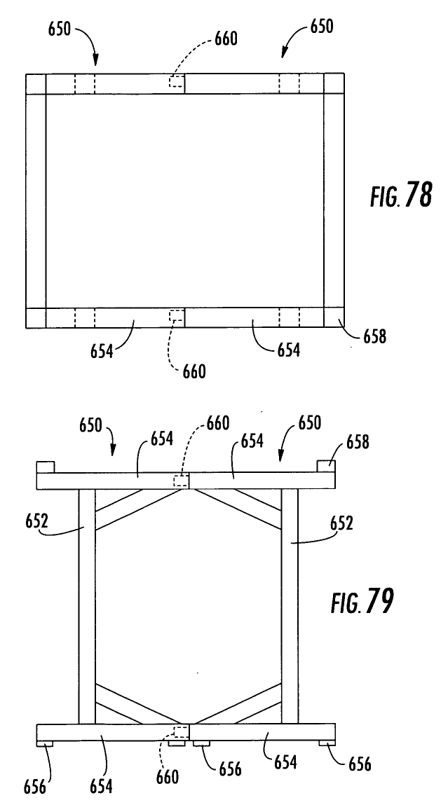

FIGS. 78 and 79 illustrate a connected pair of alternative support brackets 650. The support brackets 650 are similar in construction to the support brackets 412 described above and include vertical members 652 connected to horizontal C-shaped braces 654. The lower end of the support brackets 650 may include feet 656 while the upper ends include mounts 658 for attaching an bulk bag adapter assembly (not shown). In this embodiment, the braces 654 are dimensioned such that they meet each other in the middle when placed around a bulk bag (not shown). If desired, the support brackets 650 may be connected, for example by the illustrated tube and socket connection 660. This connection could be secured with a hitch pin (not shown). Furthermore, any other known means of connecting the support brackets 650, such as latches or mechanical fasteners, may be used instead of the tube and socket 660 so long as the two support brackets 650 are securely attached to each other. Using this embodiment, there is no need to squeeze the bulk bag to install the support brackets 650, because the support brackets meet in the middle. This eases the process of installing and removing the bulk bag from the support brackets 650.

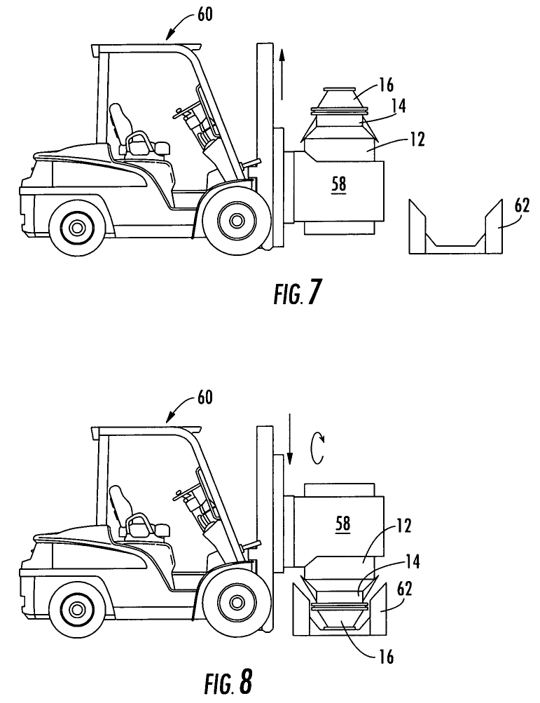

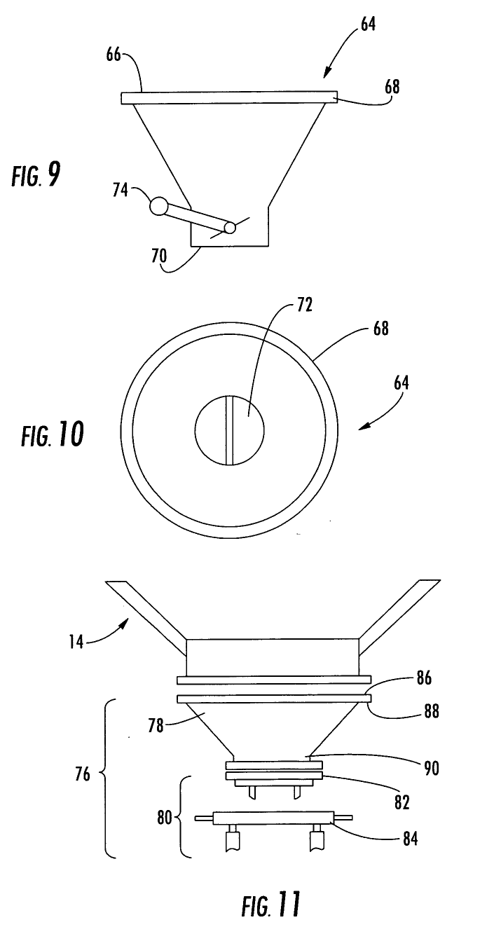

FIGS. 7 and 8 depict an example of how the bulk bags 12 may be handled. The bulk bag 12 with the adapter assembly 14 attached can be picked up using bale clamps 58 of a known type on a standard forklift 60. Bale clamps generally comprise a pair of flat or curved vertically extending panels which are mounted to the forklift 60 and selectively moved together or apart by a hydraulic cylinder to release or clamp a load there between. The bulk bag 12 is simply clamped between the bale clamps 58, and lifted from the storage area. The bulk bag 12 is then transported to the needed location and inverted by rotating the bale clamps 58. In this position, the top of the bulk bag 12 points downward. The adapter assembly 14 holds the spout 24 of the bulk bag 12 in a tensioned condition so that the bulk material can easily flow out of the bulk bag. The bulk bag 12 may then be lowered onto a discharge frame 62 which contains equipment that engages the discharge device, such as a cone valve probe (not shown). From there, the bulk material can flow out of the bulk bag 12 and to a production process.

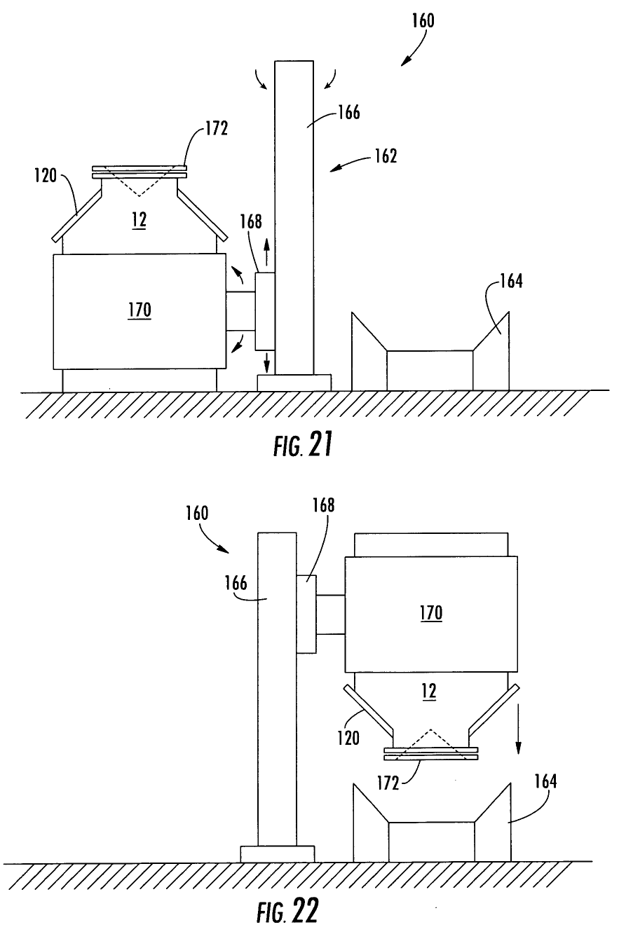

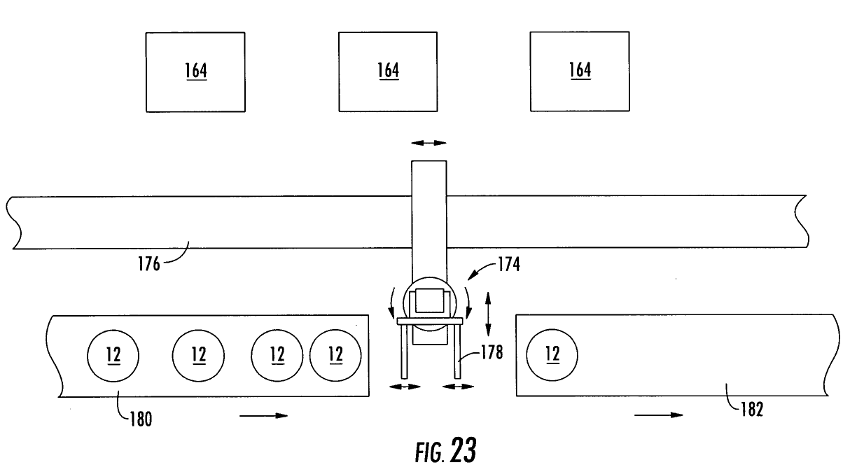

FIGS. 19 and 20 illustrate a bag clamp 148 which may be used instead of a standard bale clamp. Standard bale clamps as described above have a pair of flat panels which contact opposing sides of the load, or are curved to fit drums. However, bulk bags 12 tend to bulge out at the sides when filled with material. This bulge is not always symmetrical but may be offset towards the bottom of the bulk bag 12. The bag clamp 148 accommodates this bulge. The bag clamp 148 includes a pair of opposed, spaced-apart panels 150 which are mounted to support arms 152. The support arms 152 slide along rails 154 which are connected to a mounting frame 156. The panels 150 are selectively moved in or out by an actuator device 158, such as a pair of hydraulic cylinders of a known type. The entire bag clamp 148 can be attached to a stationary support, a forklift, or to a column lift (described below). The panels 150 are curved in both the vertical plane and horizontal planes. The curvature may be selected to suit a particular application, but in the illustrated example the panels are curved so that angles “A” (FIG. 20) and “B” (FIG. 19), both measured between a tangent line to the outer edge of the panel 150 and the vertical plane, are about 25°.

In operation, the curved panels 150 of the bag clamp 148 provide more complete contact with the bulk bag 12 than a flat clamp. The bag clamp 148 may also be used to redistribute or break up the material in the bag if it has become caked or unevenly distributed. This may be done by performing a repetitive “squeeze and release” operation in which the panels 150 are closed around the bulk bag 12 and substantial pressure is applied, and then opened to allow the material to move. This both breaks up any clumps and also tends to re-form the material symmetrically, because of the interaction of the curve of the panels 150 with the bulk bag 12.

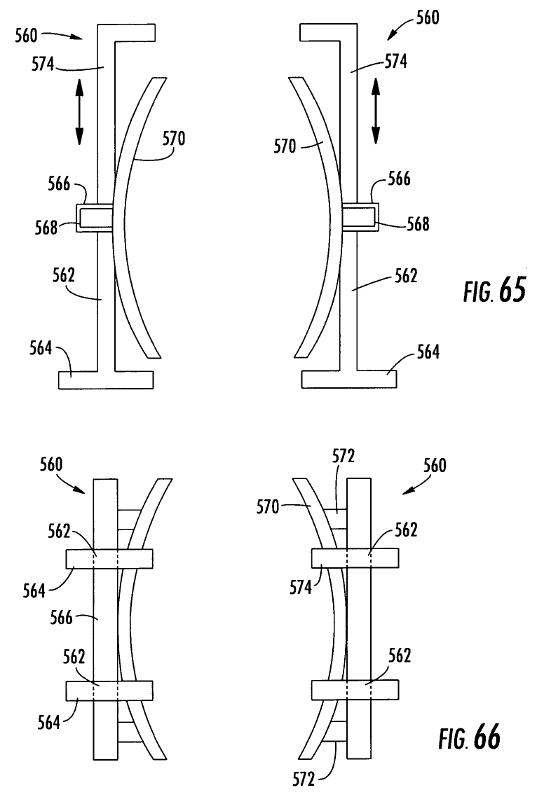

FIGS. 65 and 66 illustrate a pair of fork adapters 560 which may be used with the present invention. The fork adapters 560 are designed to allow a bulk bag 12 to be clamped, lifted, and inverted using a forklift having forks of a known type which can be adjusted for width and rotated about a horizontal axis. Each of the fork adapters includes a pair of vertical members 562 with a T-shaped base 564 that allows the fork adapter to stand upright when not in use. A horizontal member 566 having a fork slot 568 sized to accept a fork of a forklift is attached to the vertical members 562. A clamp panel 570 which is curved both vertically and horizontally is attached to the vertical and horizontal members 562 and 566 with brackets 572. An L-shaped upper support 574 which can engage an adapter assembly like those described above (not shown) may be attached to the fork adapter 560. Preferably, the upper support slides into each of the vertical members 562 and is adjustable for height as shown by the arrows in FIG. 65. For example, the upper supports 574 may be fixed in a desired position by use of a hitch pin (not shown) passing through complementary holes in the upper support 574 and the vertical member 562. The fork adapters 560 are put in use by inserting the forks (not shown) of a forklift into the fork slots 568. The fork adapters 560 may then be employed like the bag clamp 148 described above to grip, move, and invert bulk bags 12, without having to modify a standard forklift.

FIG. 59 depicts another variation of a bag clamp 440. The bag clamp 440 has a pair of panels 442 movably mounted to a frame (not shown) in a matter similar to the bag clamp 148 described above. In this case, each of the panels 442 includes a pair of spaced-apart channels 444 with an end flange 446, connected to a central section 448. As shown in FIG. 59, the channels 444 and the end flanges 446 engage the braces 422 of the support brackets 412 when the panels 442 are moved inward. This is especially useful for heavy loads, as there is direct support in both the upright and inverted positions, rather than relying solely on friction between the clamp 440 and the bulk bag 12.

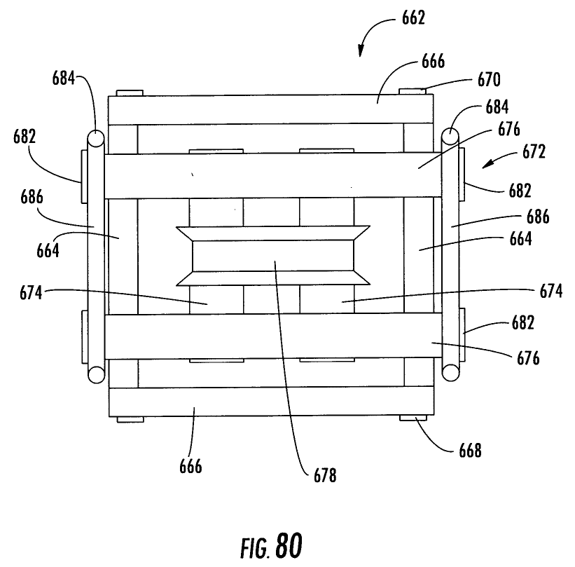

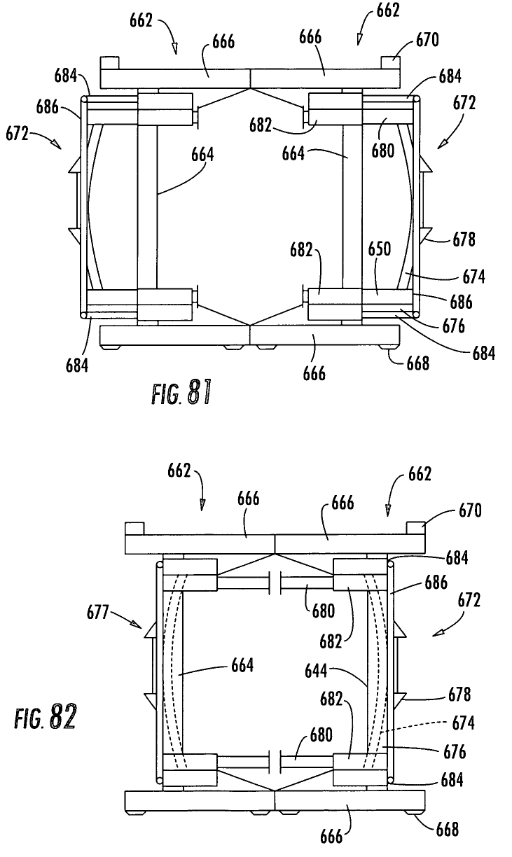

FIGS. 80 and 81 depict a pair of support brackets 662 incorporating an integral bag clamp. The support brackets 662 are similar in construction to the support brackets 650 described above. Each support bracket 662 includes vertical members 664 connected by C-shaped braces 666 which include feet 668 and mounting means 670 for a bulk bag adapter assembly (not shown). The braces 666 extend inward so that they meet each other in the middle and may be detachably connected by connecting means (not shown). Each support bracket 662 also includes a clamping assembly 672 which comprises one or more curved clamp panels 674 attached to a C-shaped clamp frame 676, a fork bracket 678 (which may be open as shown or may be a closed rectangular member), a plurality of rails 680 defined by the clamp frames 676 and retained in channels 682 attached to the support bracket 662, and biasing means to hold the clamp panels 674 in an open position. In the illustrated example the biasing means comprise air or gas charged cylinders 684 which are connected to the clamp frames 662 by struts 686.

To use the support brackets 662, they are placed around a bulk bag (not shown) which already has an adapter assembly attached thereto. The support brackets 662 are dimensioned such that they meet in the middle without having to squeeze the bulk bag. If desired, the support frames 662 may be connected to each other by connecting means such as those described above (not shown). In the rest or open position, the biasing means hold the clamp panels 674 away from the bulk bag. When it is desired to pick up, move, or invert the bulk bag, the fork brackets 678 are engaged by the forks of a forklift and then squeezed inward to a closed position by clamping the forks together, as shown in FIG. 82. This squeezes the bulk bag, causing it to be gripped firmly. When the forks are expanded and/or removed, the biasing means cause the clamp panels 674 to move outward to the open position.

FIG. 83 illustrates a variation of the apparatus shown in FIGS. 80-83. A pair of support brackets 688 are substantially similar in construction to the support brackets 662. Each support bracket 688 includes a clamp assembly 690 comprising a clamp panel 692, a fork bracket 694, and a biasing means to hold the clamp panels 692 in an open position. In this example, the biasing means is a single leaf-type spring 696. The spring 696 may be constructed of spring steel, fiberglass, composites, or similar materials.

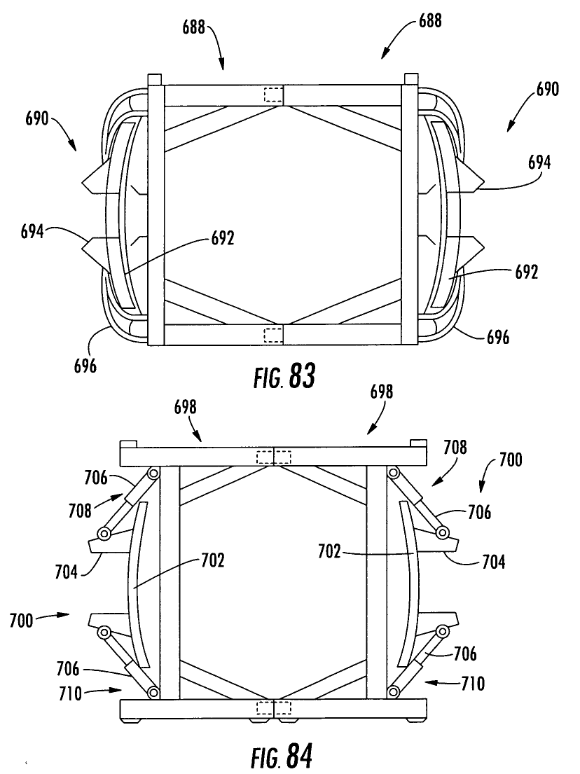

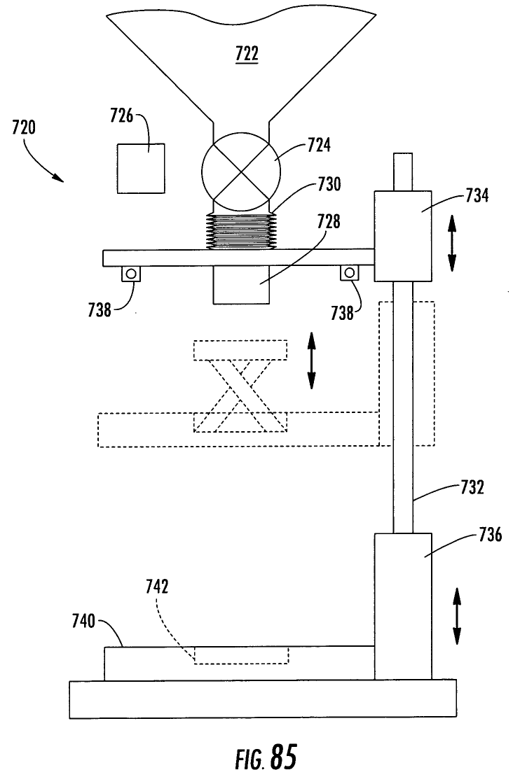

FIG. 84 illustrates another variation of the apparatus shown in FIGS. 80-82. A pair of support brackets 698 are substantially similar in construction to the support brackets 688. Each support bracket 698 includes a clamp assembly 700 comprising a clamp panel 702, a fork bracket 704, and a biasing means to hold the clamp panels 702 in an open position. In this example, the biasing means comprises air or gas charged cylinders 706 which are disposed in one or more complementary pairs of upper and lower units 708 and 710 respectively. Mounted this way, the cylinders 706 have a shorter travel than those shown in FIGS. 80-82. The cylinders 706 pivot in an arc as the clamp panels 702 are closed, thus reducing the clamping load required to maintain a closed position.

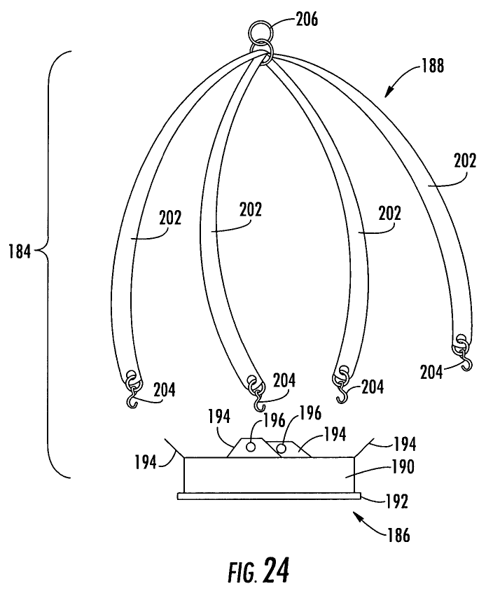

FIGS. 21 and 22 illustrate a discharge station 160 for discharging the bulk bags 12, including a column lift 162 and a discharge frame 164. The column lift 162 comprises a vertical column 166, a rotator assembly 168, and a clamp 170. The clamp 170 may be a standard bale clamp, or the alternative bag clamp 148 described above. As shown by the arrows in FIG. 21, the clamp 170 may be rotated about a horizontal axis (bag inversion), moved vertically up and down, and rotated about the vertical column 166. These motions may be powered by known types of actuators such as hydraulic cylinders and motors or electromechanical actuators.

The discharging procedure is as follows: A bulk bag 12 with an attached adapter assembly 120 and discharge device 172, such as the illustrated cone valve module, is placed upright inside the clamp 170. The clamp 170 is then closed to grip the bulk bag 12 The bulk bag 12 is then lifted upwards, rotated about the vertical column 166 until it is over the discharge frame 164, and then inverted so that the discharge device 172 faces downward. The bulk bag 12 is then lowered until it engages the discharge frame 164. The discharge frame 164 contains equipment that engages the discharge device 172, such as a cone valve probe (not shown). The contents of the bulk bag 12 may then be selectively discharged to a production process. When the discharge is complete, the bulk bag 12 may be lifted from the discharge frame 164 and removed from the clamp 170, and the process may then be repeated with another bag if necessary.

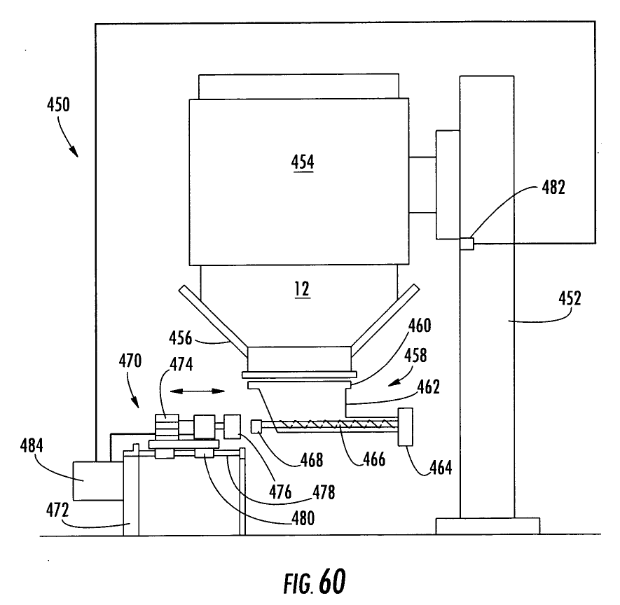

FIG. 60 illustrates another discharge station 450 for discharging the bulk bags 12, including a column lift 452 with a clamp 454 substantially the same as described above. The bulk bag 12 is fitted with an adapter assembly 456 and a screw feeder 458. The screw feeder 458 includes an attachment flange 460 for being attached to the adapter assembly 456, a tapered body 462, and an outlet 464. A screw or auger 466 of a known type is rotatably mounted in the body 462, and has a driven coupler 468. The discharge station 450 includes a drive unit 470 mounted on a frame 472. The drive unit 470 comprises a motor 474 with a drive coupler 476. The motor 474 is movable between a disengaged position and an engaged position in which the drive coupler 476 is attached to the driven coupler 468. In the illustrated example the motor 474 is slidably mounted on rails 478 and linear bearings 480 to allow it to move in and out. The motor 474 may be moved between the engaged and disengaged positions by any known means, such as a mechanical screwjack, a linear actuator, or a hydraulic piston-cylinder assembly (not shown). The drive unit 470 may also be automated. For example, the discharge station 450 may be provided with sensors 482 to detect when the screw feeder is moved to the discharge position. In response thereto, a controller 484 such as a computer or programmable logic controller of a known type may cause the drive unit 470 to move into the engaged position, coupling the drive coupler 476 and the driven coupler 468, and begin turning the auger 466 of the screw feeder 458.

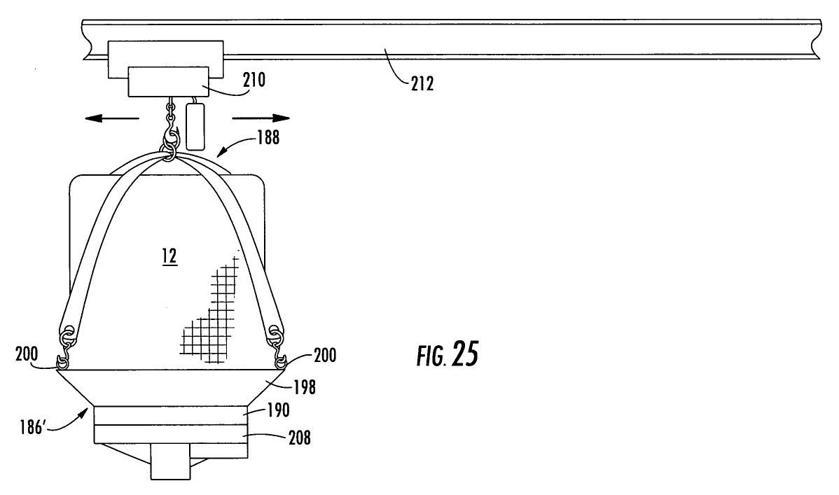

The column lift and clamps described above may also be incorporated as part of a bulk bag movement and handling system. A facility can be provided with a plurality of multiaxis lift units 174, such as that shown in FIG. 23. The multiaxis lift 174 is mounted on a floor rail system 176 and can move in the X, Y, and Z-axes. It is also equipped with a bag clamp 178. A multiaxis lift 174 can serve several discharge stations 160 where bulk bags 12 will be discharged. In operation, bulk bags 12 are brought to the multiaxis lift 174 by a known type of delivery conveyor 180 such as a roller conveyor. A bulk bag 12 on the delivery conveyor 180 is then clamped, lifted, and carried along the rail system 178 to the required discharge station 160. The multiaxis lift 174 Then raises the bulk bag 12, inverts it, positions it over the discharge station, and lowers it onto the discharge frame 164. Once the bulk bag 12 has been discharged, it can be retrieved by the multiaxis lift 174 and placed on a takeaway conveyor 182.

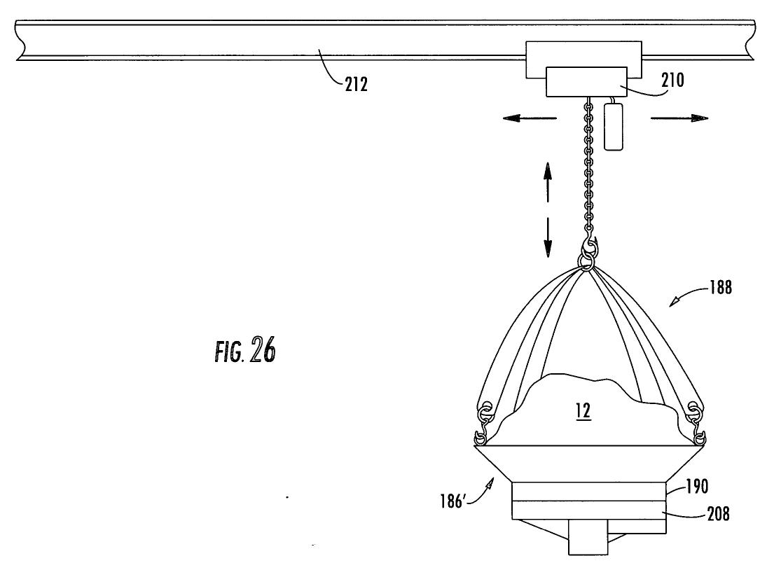

An alternative apparatus 184 for handling bulk bags 12 is illustrated in FIGS. 24, 25, and 26. FIG. 24 depicts an adapter assembly 186 and an associated harness 188. The adapter assembly 186 includes an adapter ring 190 which is a short cylindrical member having an annular, radially-outwardly extending flange 192 disposed at its lower peripheral edge. The flange 192 may take a number of forms, but preferably is it a circular-section bead similar to that of the top ring of conventional storage drum. A plurality of lift tabs 194 having eyelets 196 formed therethrough are disposed around the periphery of the adapter ring 190 on the end opposite the flange 192. Alternatively, a tapered section 198 may be attached to the adapter ring (see the alternative adapter ring 186′ in FIG. 25), and provided with a number of vertically-extending eyebolts 200. Referring again to FIG. 24, a harness 188 comprises a plurality of load straps 202 made from a material such as ballistic nylon. Each of the load straps 202 has a lift hook 204 attached to its lower end and is connected at its upper end to a lift ring 206.

FIG. 25 shows how a bulk bag 12 may be lifted by means of the harness 188 and the adapter assembly 186′. The adapter assembly 186′ is attached to the bulk bag 12 in the manner described above, and a discharge device 208 may be attached to the adapter assembly 186′. The lift hooks 204 are then attached to the eyebolts 200 or eyelets 196. The bulk bag 12 may then be lifted and transported using known types of equipment such as the illustrated hoist 210 which runs on an overhead rail 212. Rails 212 may be installed in any required location. For example, a rail 212 may be provided which runs from a warehouse to a production facility. Once hoisted, the bulk bags 12 may be moved to the needed location and discharged in the manner described above. FIG. 26 illustrates a empty bulk bag 12 suspended by a harness 188.

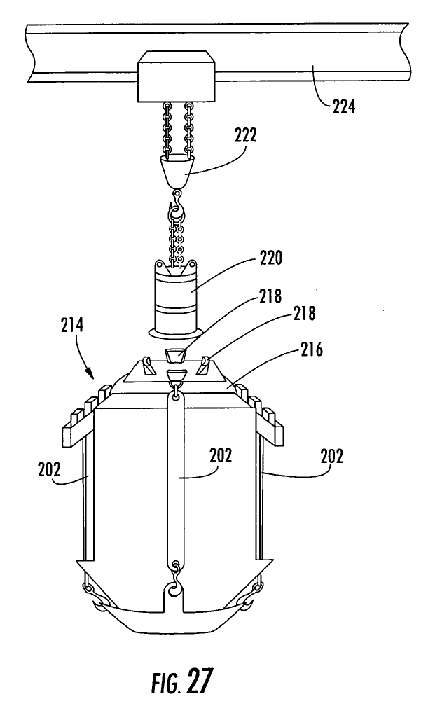

FIG. 27 shows an alternative harness 214 which includes a top plate 216 with vertically-extending guides 218. The harness 214 is attached to a bulk bag 12 by connecting straps 202 to the outer edges of the top plate 216 and to an adapter assembly 186′ similar to that described above. The bulk bag 12 may then be lifted by a vacuum lift 220 of a known type suspended from a hoist 222 and rail 224. The flat top plate 216 provides the smooth surface needed for the vacuum lift 220 to “grip”. The bulk bag 12 may then be moved along the rail 224 to the needed location where it is lowered into place and the vacuum released.

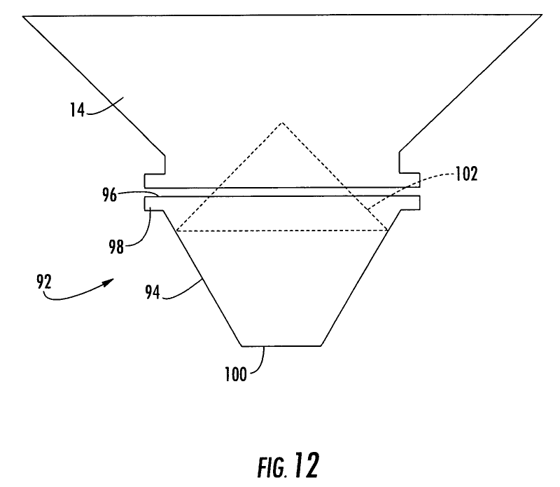

The adapter assemblies described above may be used with a number of different discharge devices. One example of a discharge device is a funnel module 64, shown in FIGS. 9 and 10. The funnel module 64 comprises a generally conical body having an inlet end 66 with a mounting flange 68 and an outlet end 70 with a disk-type shutoff valve 72 controlled by a lever 74. The funnel module 64 may be of a known type used for rigid drums. The funnel module 64 is attached to the top of the bulk bag 12 by using a drum ring clamp 54 as shown in FIG. 6, or by an integral ring clamp on the mounting flange (not shown). Once the funnel module 64 is attached, the bulk bag 12 may be inverted. The shutoff valve 72 prevents flow in the closed position and permits flow in the open position.

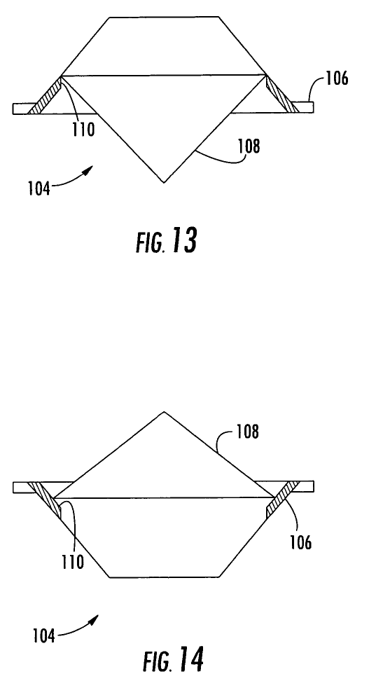

FIG. 11 illustrates an adapter assembly 14 in conjunction with a split butterfly valve module 76. The butterfly valve module 76 includes a fairing 78 and a split butterfly valve 80 which has a passive valve 82 and an active valve 84. The fairing 78 is a generally conical structure having an inlet end 86 with a mounting flange 88 and a discharge end 90 to which the passive valve 82 is mounted. The passive valve 82 contains a passive valve disk (not shown) that blocks flow out of the bulk bag 12. The passive valve disk is locked into the closed position, and thus the bulk bag 12 may be stored without leakage. To discharge material from the bulk bag 12, it is inverted and the passive valve 82 is locked onto the active valve 84. When the active and passive valves are connected, they are interlocked so that they may both be opened, allow the flow of material. The split butterfly valve 80 may be a STERI-SPLIT valve, available from SteriValves srl, Mugnano Lucca ITALY.

FIG. 12 illustrates yet another discharge device in the form of a cone valve module 92. The cone valve module 92 includes a funnel 94 having an inlet 96 with a mounting flange 98 for being attached to an adapter assembly 14, and an outlet 100. A cone 102 is disposed inside the funnel 94. The perimeter of the cone 102 rests on the interior surface of the funnel 94 and provides a seal when the bulk bag 12 and cone valve module 92 are inverted. When the cone 102 is raised and pulsed, for example by a known type of external probe system, it lifts upward into the material above and agitates the material. The material flows around the perimeter of the cone 102 and through the outlet 100.

The cone valve module 92 described above is similar to existing types of cone valves. However, prior art cone valves are not intended to be used in an inverted position. If a conventional cone valve were used with the adapter assembly 14 of the present invention, it would fall into the bulk bag 12 when the bulk bag 12 was stored top end up. This would expose the material inside the bulk bag 12 and result in spillage when the bulk bag 12 was inverted. Accordingly, FIGS. 13 and 14 show an alternative cone valve module 104 which addresses this problem. The cone valve module 104 is substantially similar to that shown in FIG. 12 above and includes a funnel 106 and a cone 108. In this embodiment, the funnel 106 includes a ledge 110 which interferes with the periphery of the cone 108 and prevents the cone 108 from falling into the bulk bag (not shown) when the bulk bag is stored. FIG. 14 illustrates the cone valve module 104 in the discharge position. When the material is to be discharged, the cone 108 is forced upwards past the ledge 110 by the first pulse of the probe (not shown). Subsequently, the cone 108 operates as described above with respect to the cone valve module 92 of FIG. 12. The release of the cone 108 is accommodated by the selection of the dimensions and materials of the ledge 110 and the cone 108. For example, the diameters of the cone 108 and the ledge 110 may be set so that there is only a slight interference of the two. Furthermore, the cone 108 or the funnel 106 or both may be constructed of a resilient material such as plastic or rubber, thus enabling a slight deflection when the cone 108 is forced past the ledge 110.

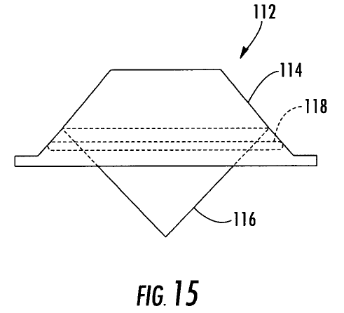

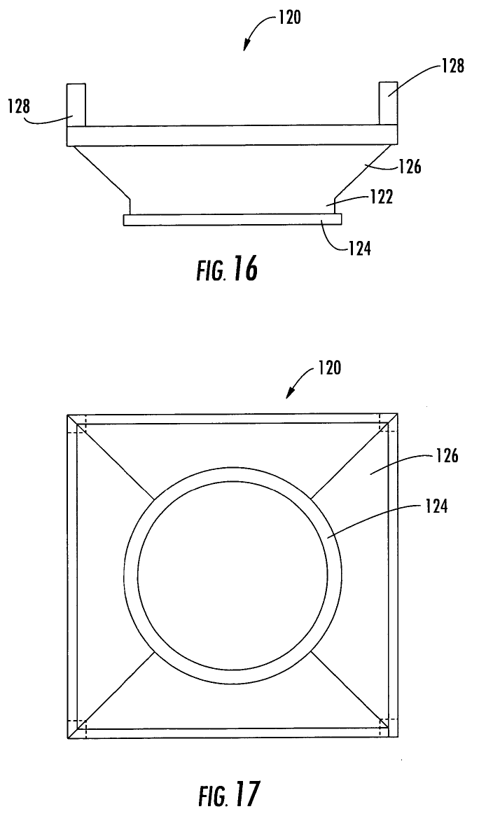

FIG. 15 shows another alternative cone valve module 112 which addresses the problem of cone retention. The cone valve module 112 is substantially similar to that shown in FIG. 12 above and includes a funnel 114 and a cone 116. In this embodiment, a deformable retainer 118 is disposed inside the funnel 114 in a position where it interferes with the periphery of the cone 116. The retainer 118 may be a hollow inflatable ring connected to an air source (not shown). When the retainer 118 is inflated it holds the cone 116 in place as shown. When the retainer 118 is deflated it allows the cone 116 to function normally.

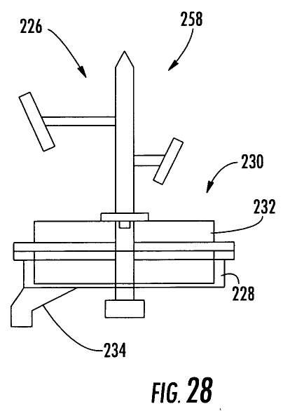

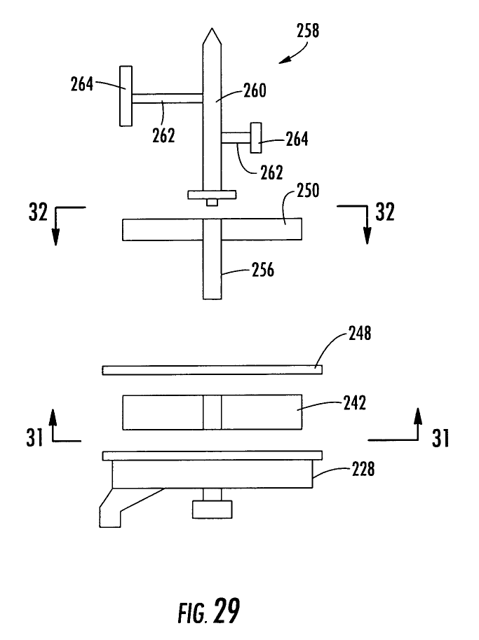

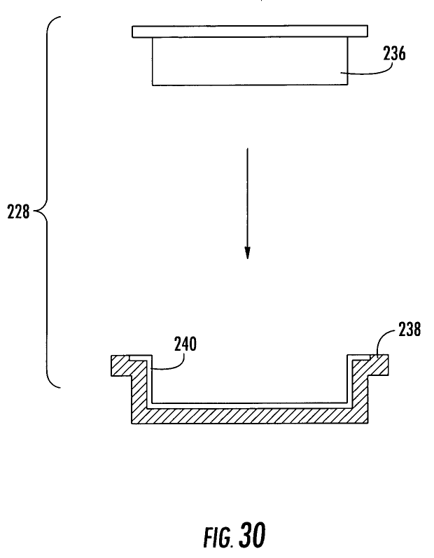

FIG. 28 illustrates a discharge device in the form of a disk feeder 226. The disk feeder 226 includes a housing 228 having an inlet 230 with a mounting flange 232 for being attached to an adapter assembly 14, and an outlet 234. FIG. 29 is an exploded view showing the components of the disk feeder 226 in more detail. The housing 230 is a hollow, open-ended member and may be constructed of a material appropriate to the intended material to be discharged from the bulk bags 12. In many instances, such as food handling or pharmaceutical production, it may be necessary to construct the housing out of a material that can be disinfected and that will not contaminate the product, such as stainless steel. However, this material is relatively expensive and heavy. Accordingly, the housing 228 may be split into an inner housing 236 and an outer housing 238, as shown in FIG. 30. The inner housing 236 is a form-fit that slides into a recess 240 in the outer housing 238. The inner housing 236 is constructed from a sanitary material such as stainless steel, while the outer housing 238 may be of a less expensive and/or lighter material such as carbon steel, aluminum, or plastic.

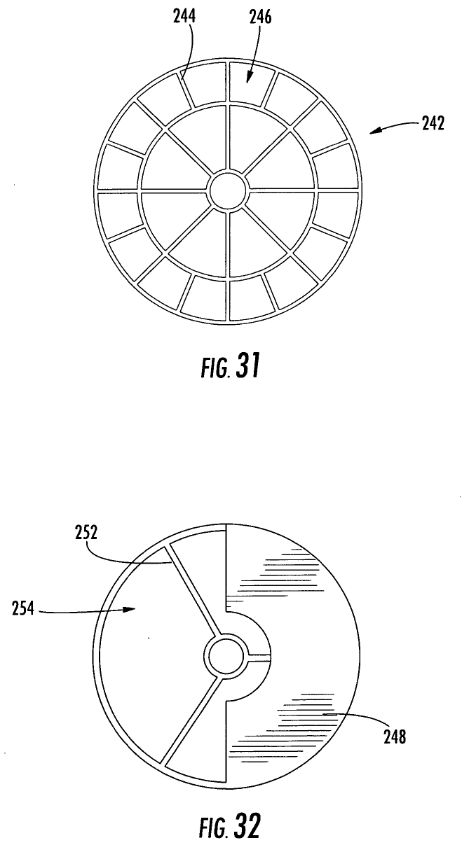

Returning to FIG. 29, the housing receives a lower rotor 242. The lower rotor 242 contains a plurality of radially-extending dividers 244 defining several lower pockets 246 for receiving material (see FIG. 31). A divider plate 248 is placed on top of the lower rotor 242. As shown in FIG. 32, the divider plate 248 obstructs approximately half of the area of the lower rotor 242. An upper rotor 250 is installed on top of the divider plate 248. As shown in FIG. 32, the upper rotor 250 has a plurality of radially-extending dividers 252 defining several upper pockets 254. Preferably these upper pockets 254 are substantially larger than the lower pockets 246. A drive shaft 256, which may be attached to the upper rotor 250, passes through the divider plate 248 and lower rotor 242. The drive shaft 256 is rotatable relative to the housing 228 and causes both the lower and upper rotors to turn simultaneously (for example by being splined to the lower rotor). An agitator 258 is attached to the shaft 256 and rotates with it. The agitator 258 comprises a central post 260 and several outwardly-extending arms 262 with scrapers 264. The scrapers 264 may be oriented vertically as shown in FIG. 29, or the may be angled outward as shown in FIG. 28.

When the disk feeder 226 is to be used, the drive shaft 256 is connected to a power source, and the agitator 258, upper rotor 250, and lower rotor 242 are rotated in unison. The agitator 258 breaks up any clumps in the material in the bulk bag 12, which is free to drop into the upper pockets 254 of the upper rotor 250. The upper rotor 250 pushes the material around to the open portion of the divider plate 248, where is it free to fall into the lower pockets 246 of the lower rotor 242. The lower rotor 242 then pushes the material around until it is over the outlet 234, where it is free to discharge to the production process. It is noted that this two-stage design improves the accuracy of feeding, but if desired the disk feeder 226 may be constructed with a single rotor to reduce cost and complexity.

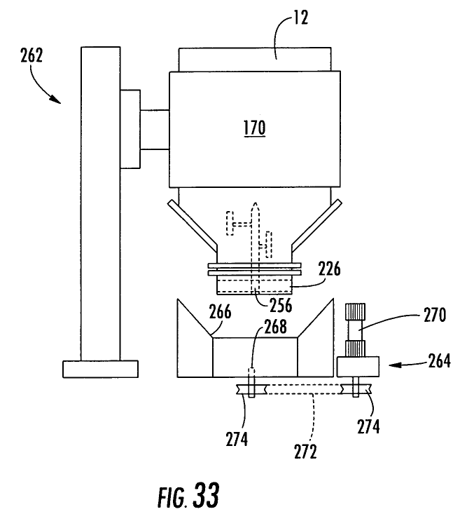

A variety of means may be used to turn the drive shaft 256. FIG. 33 illustrates a discharge station 262 having an integral drive means 264. The discharge station 262 is substantially similar to that described above. It includes a discharge frame 264. A center shaft 268 is rotatably mounted in the discharge frame 264, and is driven by a motor 270 through a belt 272 and pulleys 274, or other equivalent mechanical connection. When the disk feeder 226 is lowered onto the discharge frame 264, the drive shaft 256 engages the center shaft 268 so that they rotate in unison. For example, the drive shaft 256 may be equipped with internal splines and the center shaft 268 may be equipped with external splines.

FIG. 34 illustrates a discharge station 276 which includes a weighing system and/or a loss-in-weight delivery system. The discharge station 276 includes a discharge frame 278 with an electric motor 280 mounted thereto. A bulk bag 12 with a disk feeder 226 is attached (for example by suitable gears) to a center shaft 282 driven by the motor 280. The discharge frame 278 is arranged so that its top member 284 is supported by one or more weight sensors 286 such as a known type of electronic scale or load cell. When the bulk bag 12 is placed on the discharge frame 278, its weight is stored and/or indicated by the controller 288, which may be a standard digital computer. The contents of the bulk bag 12 may then be discharged by operating the disk feeder 226 with the motor 280. As the bulk bag 12 empties, its weight is reduced, and the difference between the initial weight and any subsequent weight is equal to the weight of material discharged. The controller 288 may be connected to both the motor 280 and the weight sensors 286 and programmed to discharge a specific quantity of material. When started, the controller 288 would then store the initial weight measurement and start the motor 280 to begin discharge. During the discharge, the controller 288 would periodically read the weight values and stop the motor 280 when the desired amount of material has been discharged.

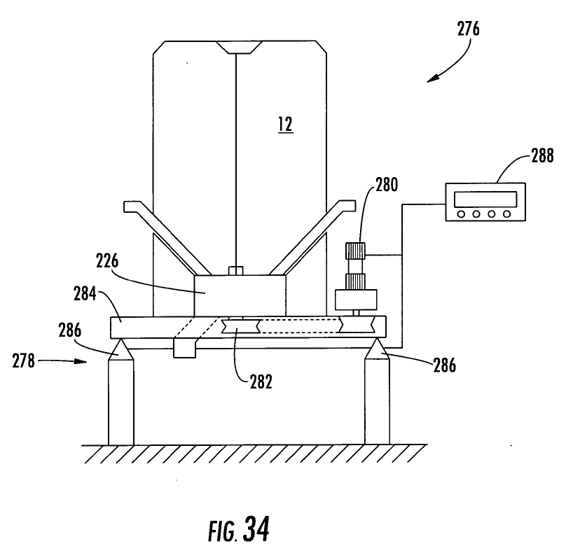

FIG. 35 illustrates a method of tensioning the a bulk bag 12. As noted above, the spouts 24 of the bulk bags 12 may be tensioned by the adapter assembly 120 alone. As the bulk bags 12 empty, they naturally collapse if not supported. In the prior art the bulk bags 12 have been supported from the top by using loops and suspension equipment. However, this type of suspension equipment exacerbates the problem of excessive height requirements. FIG. 35 shows a bulk bag 12 attached to an adapter assembly 120 having stub posts 128. A plurality of tensioning devices 290 having upper and lower ends 292 and 294 are attached to the adapter assembly 120. The lower ends 294 of the tensioning devices 120 are attached to the stub posts 128 and the upper ends 292 are received in the pockets 40 of the bulk bag 12. The tensioning devices 290 serve both to support the bulk bag 12 when it is in a filled condition, to prevent it from slumping on the adapter assembly 120, and also to maintain the bulk bag 12 in a tensioned condition as the contents are emptied during a discharging operation. In the illustrated example the tensioning devices 290 are rigid, elongated members which each include a probe 296 that is shaped to be received in the pockets 40, and an actuator 298. The actuator 298 could be a compression spring cartridge of a known type, a hydraulic piston-cylinder assembly, or electric screwjack. The function of the actuator 298 is provide an upward force on the inverted bulk bag 12 so that it under constant tension. If a controllable actuator such as a hydraulic cylinder is used, the bulk bag 12 may also be selectively raised or lowered independent of how full it is. For example the tensioning devices 290 may be alternatively raised and lowered to agitate the contents of the bulk bag 12.

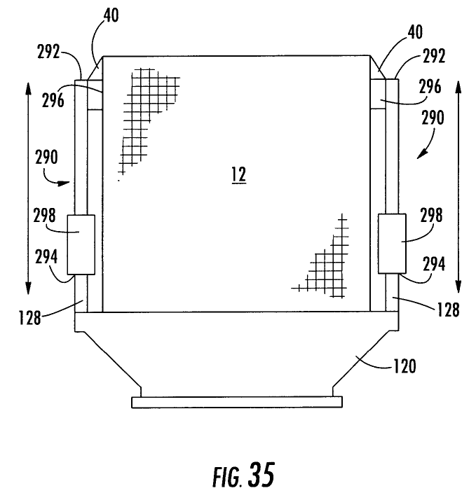

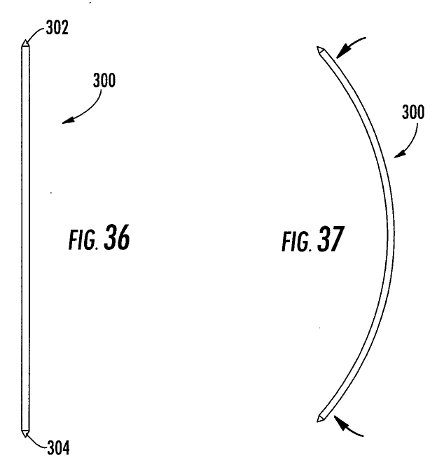

The tensioning devices may be constructed in a number of different ways. FIGS. 36 and 37 illustrate a tensioning device 300 which is a simple resilient flexible rod having first and second tapered ends 302 and 304. The length of the tensioning device 300 is chosen so that it will maintain a full bulk bag 12 at the proper tension. As shown in FIG. 37, the tensioning device 300 may be bent in a curve to allow installation into the pockets of the bulk bag 12 and then released to place the bulk bag 12 under tension. A variety of materials may be used for the tensioning device so long as they provide adequate tension and resiliency, for example fiberglass, carbon or graphite containing composites, and the like.

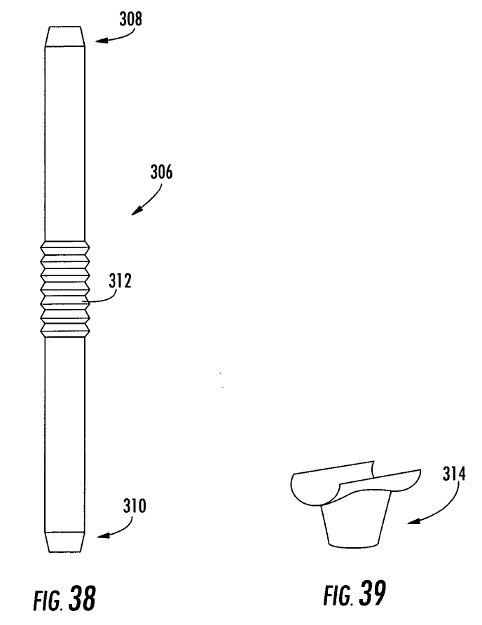

FIG. 38 depicts a compression-type tensioning device 306. The tensioning device 306 is extendible in length and has a first end 308 adapted for a engaging an adapter assembly and a second end 310 adapted for engaging a pocket of the bulk bag 12. The entire tensioning device 306 is biased to extend outward, for example by a spring cartridge enclosed by a bellows 312. The tensioning device 306 is installed by compressing it so that it will fit between the pockets of the bulk bag 12 and the adapter assembly, and then released to place tension on the bulk bag 12. Different types of end adapters may be provided for the tensioning device 306 depending on how it is to be mounted, for example the truncated cone end shown in FIG. 38 or the cylindrical saddle end 314 shown in FIG. 39.

FIG. 40 shows another method of implementing the tensioning devices. A bulk bag 12 is shown mounted along with an adapter assembly 120 on a discharge frame 316. A plurality of tensioning devices 318 each consisting of a base 320 and an extensible actuator 322 such as a pneumatic piston-cylinder assembly are attached to the discharge frame 316. The upper ends of the actuators 318 are received in the pockets 40 of the bulk bag 12. When the actuators 318 are extended, they hold the bulk bag 12 upwards in a tensioned condition.

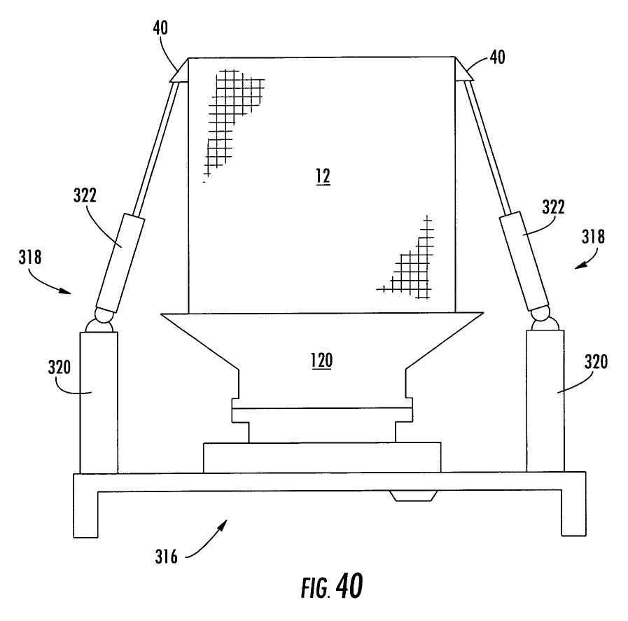

FIG. 41 illustrates a variation of the bulk bag 12. The bulk bag 324 is substantially similar to the bulk bag 12, being a cubic or rectangular envelope having a top panel 326, a lower panel 328, and a plurality of side panels 330. However, in the bulk bag 324, both the top panel 326 and the bottom panel 328 are formed into tapered spouts 330 and 332, respectively. Each spout 330 and 332 gradually transitions from the square shape of the bulk bag 12 to a circular outlet 334 and 336, respectively, and may include the dual tapered shape described above with respect to the bulk bag 12. Each outlet 334 and 336 comprises a short cylindrical section 338 and 340 respectively and an optional circumferential flap 342 and 344 respectively. The flaps 342 and 344 may include a reinforcement ring (not shown), as described above. The bulk bag 324 includes a plurality of mounting means 325 attached thereto. In the particular example illustrated, a plurality of straps 346 formed from straps of material affixed to the bulk bag 324 near the juncture of the body of the bulk bag 12 and the spouts 330 and 332, and a plurality of pockets 348 are attached to the bulk bag 324 between the straps 346. The straps 346 and pockets 348 are used to mount the bulk bag 324 and to tension it. The mounting means 325 may comprise a number of different structures so long at they allows the bulk bag 324 to be attached to a supporting structure.

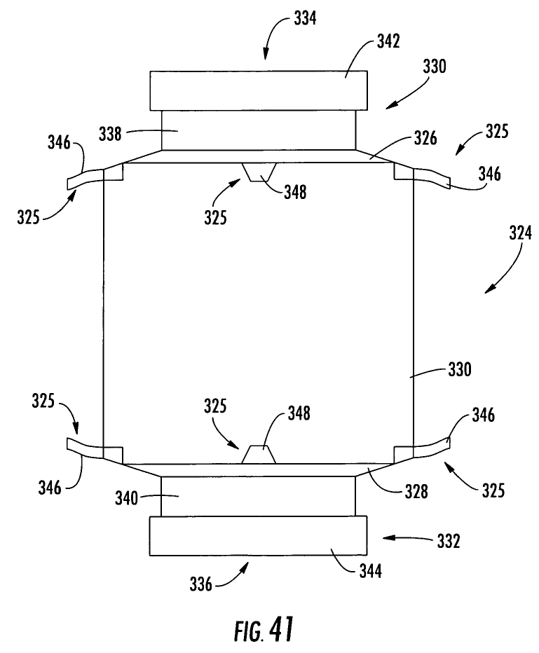

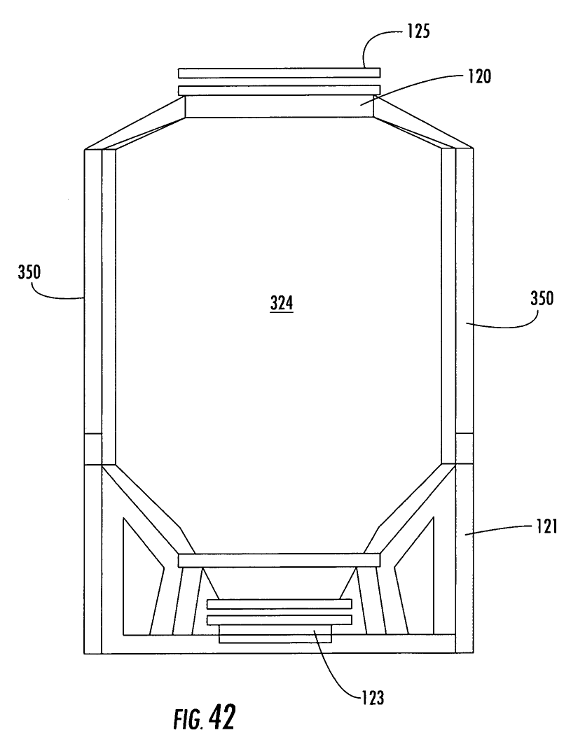

The bulk bag 324 thus may be attached to two separate adapter assemblies, one at each end. The bulk bag 324 may be filled from the top end and discharged from the bottom end without having to invert it. Furthermore, the bulk bag 324 may be used as a storage container, much like a soft-sided silo, by attaching an adapter assembly 120 and 121 to the upper and lower ends, respectively and by inserting a or a frame 350 between each of the adapter assemblies 120 and 121 as shown in FIG. 42, The bulk bag 324 is secured to the frame 350 using the mounting means 325. One or more tensioning devices (not shown) may be inserted between opposed pairs of pockets 348. A discharge device 123 may be attached to the lower adapter assembly 123 and a drum lid 125 may be attached to the upper adapter assembly 125.

FIGS. 43 and 44 illustrate a bag drum 352 which is constructed according the principles of the bulk bags 12 described above. The bag drum 352 comprises a bag 354 attached to a bag ring 356 and supported by one or more tensioning rods 358. The bag 354, shown in FIG. 43, is constructed of fabric as described above, but is made in the shape and size of a standard cylindrical drum. The bag 354 includes a spout 360 and a flap 362 at the open upper end 364, and a plurality of pockets 366 disposed around the closed lower end. A cylindrical bag ring 356 is provided which includes a flange 368 and which substantially similar to the adapter rings described above. As shown in FIG. 44, the bag ring 356 is attached to the bag 354 by pulling the flap 362 thorough the bag ring 356 and folding it over. The flap 362 may then be secured by a conventional drum ring clamp (not shown). At least one resilient tensioning rod 358 is installed between the drum ring 356 and the pocket 366. Thus assembled, the bag drum 352 may be handled, stored, filled, and discharged like a conventional rigid drum, but at substantially lower cost and weight. Any standard drum accessory, such as the funnel valve 370 shown, may be attached to the flange 368 of the drum ring 356.

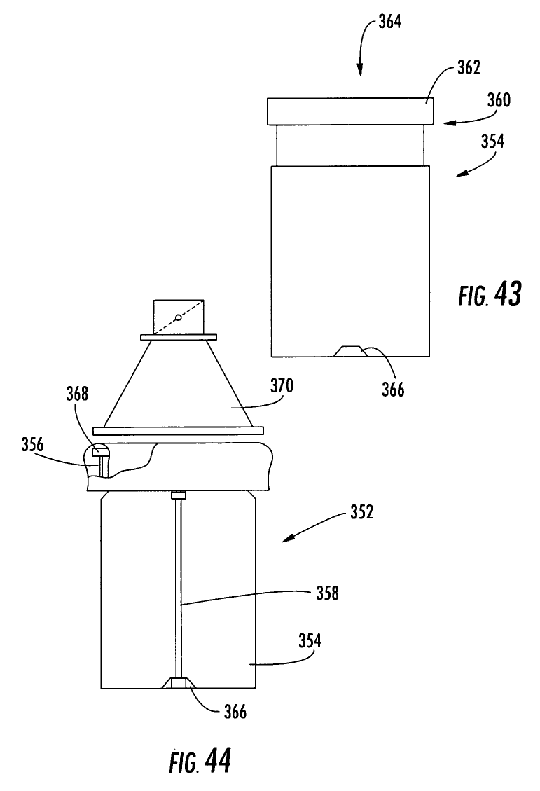

FIGS. 45 and 46 illustrate a filling apparatus 372 for loading bulk material into bulk bags 12. The filling apparatus 372 includes a storage hopper 374 with a valve 376, a reversed funnel 378, and a spring-balanced lift table 380 of a known type. The reversed funnel 378 has upper and lower flanges 382 and 384 and is connected to the storage hopper 374 with a drum clamp 386. A cone-shaped deflector 388 is suspended from the center of the reversed funnel 378, for example with cables 390. To fill a bulk bag 12, the bulk bag 12 with an adapter assembly 392 of the type described above is placed onto the lift table 380. The lower flange 384 of the reversed funnel 378 is then attached to the adapter assembly 392, for example with a drum clamp (not shown). The valve 376 is then opened and the material allowed to flow into the bulk bag 12. As the material flows, it strikes the deflector 388 and is urged towards the sides of the bulk bag 12. Unlike prior art filling methods, the material does not form a conical pile with a central peak, but rather fills in a more level manner. This eliminates voids in the material which can lead to lopsided bags. As the fill progresses, the sides of the bulk bag 12 are stretched out and the bulk bag 12 extends. This motion is accommodated by compression of the lift table 380, as shown in FIG. 46. As the bulk bag 12 is filled, air is allowed to escape through an air vent 394 in the reversed funnel 378. If desired, a dust extraction hose 396 from a vacuum system of a known type (not show) may be attached to the air vent 394 to extract any dust generated during the filling process. When the fill is complete, the valve 376 is closed and the bulk bag 12 may be removed from the lift table 380.

FIG. 70 illustrates an alternative filling apparatus 580 for loading bulk material into bulk bags 12. The filling apparatus 580 includes a storage hopper 582 with a gate valve 584 controlled by an actuator 586, a feed tube 588 with an inflatable collar 590 of a known type, and a spring-balanced or preferably a powered lift table 592 of a known type. A cone-shaped deflector 594 is suspended from the collar 590, for example with cables 596. The bulk bag 12 is supported from the filling apparatus 580, for example using straps 598 attached to the bag mounting means 37. To fill a bulk bag 12, the bulk bag 12 with an adapter assembly 600 of the type described above is placed onto the lift table 592, connected to the straps 598, and the collar 590 is inflated to seal against the adapter assembly 600. The bulk bag 12 is then raised by the lift table to an upper position (not shown). The gate valve 584 is then opened and the material allowed to flow into the bulk bag 12. As the material flows, it strikes the deflector 594 and is urged towards the sides of the bulk bag 12. As the bulk bag 12 is filled, it is slowly lowered at a controlled rate so that the product cannot become aerated. Once the bulk bag 12 has reached a desired fill level, the gate valve 584 may be closed. The bulk bag 12 may then be detached from the straps 598 and released from the inflatable collar 590. The entire filling sequence, i.e. the gate valve and lift table operation, may be controlled using a computer or a programmable logic controller (PLC) of a known type (not shown).

FIG. 85 illustrates another alternative filling apparatus 720 for loading bulk material into bulk bags (not shown). The filling apparatus 720 includes a storage hopper 722 with a valve 724 controlled by an actuator 726 and a feed tube 728 with an extendible collar 730 of a known type. A vertical column 732 supports an upper bag lift 734 and a lower bag lift 736. Each of the bag lifts 734 and 736 includes known means for moving it selectively up and down the column 732, for example an electric screwjack. The upper bag lift 734 includes hangers 738 for engaging the mounting means at the upper end of a bulk bag. The lower bag lift 736 includes a platform 740 which houses a powered center lift 742. The platform 740 is large enough to support a bulk bag, for example it may be a square about 122 cm (48 in.) on a side. The center lift 742 is similar to the lift table 592 described above, but is smaller, for example it may be a square about 30.5 cm (12 in.) on a side. The center lift 742 and lower bag lift 736 are shown both in the raised position in dashed lines in FIG. 86.

To fill a bulk bag, the bulk bag with an adapter assembly (not shown) of the type described above is connected to the feed tube and supported from the upper bag lift 734 and the lower bag lift 736. The lower bag lift 736 is raised to its highest position. The center lift 742 may then be raised. This lifts the center of the bulk bag as near as possible to the feed tube. The valve 724 is then opened and the material allowed to flow into the bulk bag 12. As the material flows, it piles up into a cone shape assisted by the center lift 742, and is urged towards the sides of the bulk bag. As the bulk bag 12 is filled, the lower bag lift is slowly lowered at a controlled rate so that the product cannot become aerated. The lower bag lift 736 may also be oscillated up and down to deaerate the product if necessary. Once the bulk bag has reached a desired fill level, the valve 724 may be closed. The center lift 742 maybe lowered to urge the contents of the bulk bag into a uniform shape with a level surface. The bulk bag may then be detached from the upper and lower bag lifts 734 and 736 and released from the feed tube 728. The entire filling sequence, i.e. the valve opening, and upper, lower, and center lift operations, may be controlled using a computer or a programmable logic controller (PLC) of a known type (not shown).

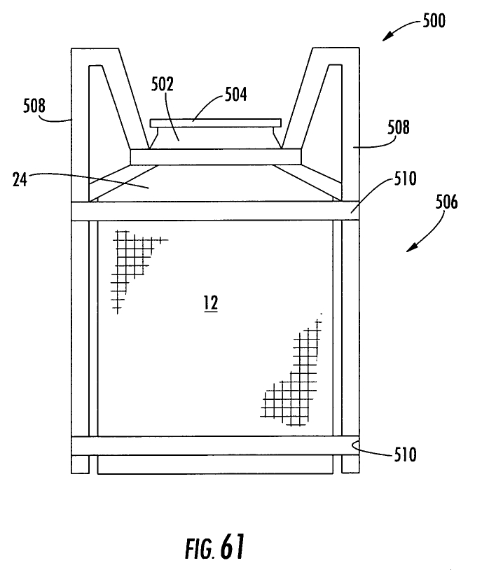

The adapter assembly has been described as a separate, modular unit which is attached to or removed from a bulk bag 12 as needed. However, it is It is possible that the same principles may be incorporated into a stationary or quasi-stationary unit. For example, in some types of materials handling it may be necessary that all of the handling equipment be made of stainless steel or a similar material which would make individual adapter assemblies too heavy to be easily manipulated. FIG. 61 illustrates an alternative adapter assembly 500 which comprises a transition section 502 having a flange 504, and a support frame 506. The support frame 506 is a unitary structure including several vertical members 508 and horizontal members 510 and is significantly heavier than the adapter assemblies described above. In use, the entire adapter assembly 500 may be placed over the bulk bag 12, for example using a hydraulic lift (not shown). The spout of the bulk bag 12 is attached to the flange 504 in the manner described above. The entire adapter assembly 500 is then inverted so that the contents of the bulk bag 12 may be discharged. Although it is not readily portable, this embodiment of an adapter assembly 500 still performs the functions of supporting the spout 24 of the bulk bag 12 and providing a common attachment structure (i.e. the flange 504).

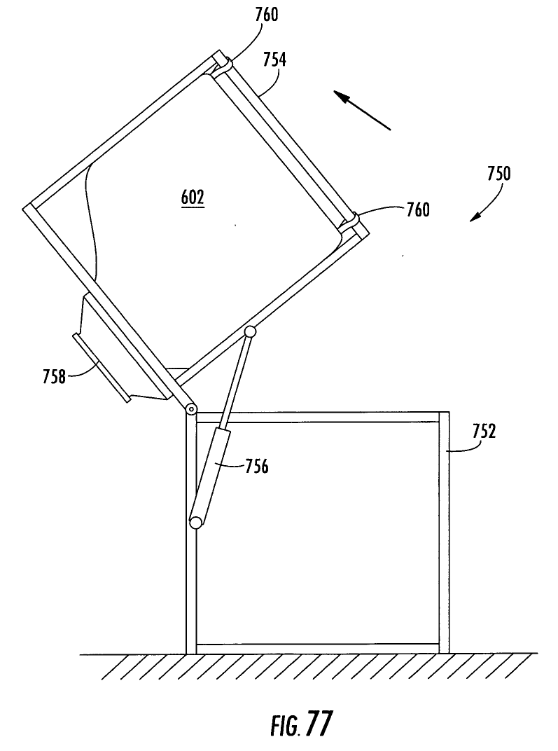

FIG. 76 illustrates an alternative bulk bag 602. It is substantially identical in construction to the bulk bag 12. However, its spout 604 is laterally offset from the center. The offset spout 604 allows the bulk bag 602 to be used more readily with stationary dispensing equipment, such as a standard box dumper of a known type. An example of such a box dumper 750 is shown in FIG. 77. It includes a stationary frame 752, a pivoting frame 754, and a pivot means such as a hydraulic cylinder 756. A bulk bag adapter assembly 758 such as those described above is attached to the pivoting frame 754. A bulk bag 602 with an offset spout may be placed inside the pivoting frame 754 and attached to the adapter assembly 758. The bottom of the bulk bag 602 is then secured to the pivoting frame 754, for example with straps 760. After the bulk bag 602 is mounted in the pivoting frame 754, the pivoting frame 754 can then be raised to empty the contents of the bulk bag 602 in a known fashion.

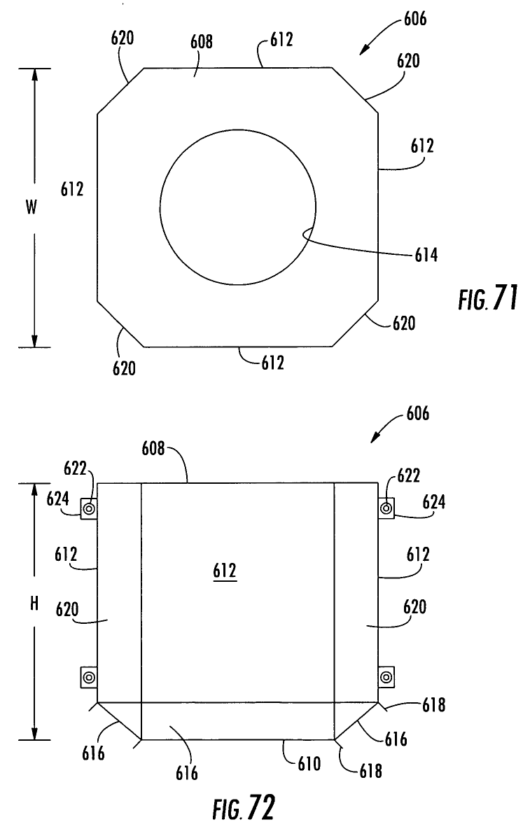

FIGS. 71 and 72 illustrate another variation of a bulk bag 606 for use with the present invention. The bulk bag 606 is similar in construction to the bulk bags 12 described above and has a cubic or rectangular envelope having a top panel 608, a lower panel 610, and a plurality of side panels 612. The bulk bag 606 may be made from any strong, flexible material. One suitable material comprises woven polypropylene fabric. The bulk bag 606 may be fabricated by sewing individual panels together. The dimensions of the bulk bag 606 may be varied to suit a particular application, however in common applications the capacity of the bulk bag 606 is typically from about 230 kg (500 lbs.) to about 2000 kg (4500 lbs.) In the illustrated example, the bulk bag 606 has a width W of about 91 cm (36 in.), and a height H of about 107 cm (42 in.) The top panel 608 of the bulk bag 606 includes an opening 614 and may include a tapered or straight spout as described above (not shown). The bulk bag 606 includes a plurality of angled base panels 616 disposed around the bottom periphery of the bulk bag 606 Between the side panels 612 and the bottom panel 610. The seams 618 connecting the angled base panels are exaggerated in FIGS. 71 and 72 for illustrative clarity. The bulk bag 606 also includes a plurality of angled corner panels 620 disposed between adjacent ones of the side panels 612. When the bulk bag 12 is filled, it thus forms a cubic or rectangular shape with beveled side and bottom corners. The bulk bag 606 includes a plurality of mounting means attached thereto. In the particular example illustrated, the mounting means comprise a plurality of eyelets 622 disposed in flexible tabs 624 attached to the bulk bag 12. However, the mounting means could be implemented in a variety of ways, as described above.

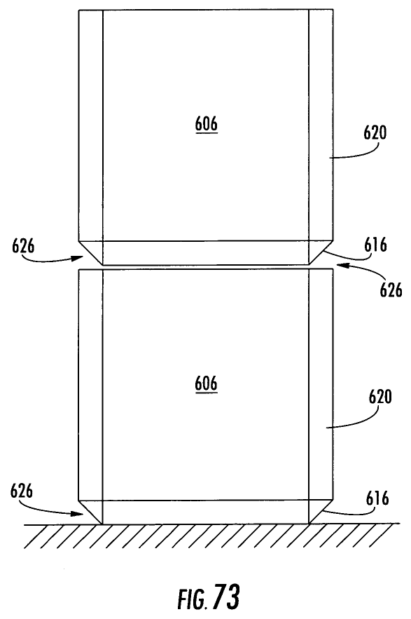

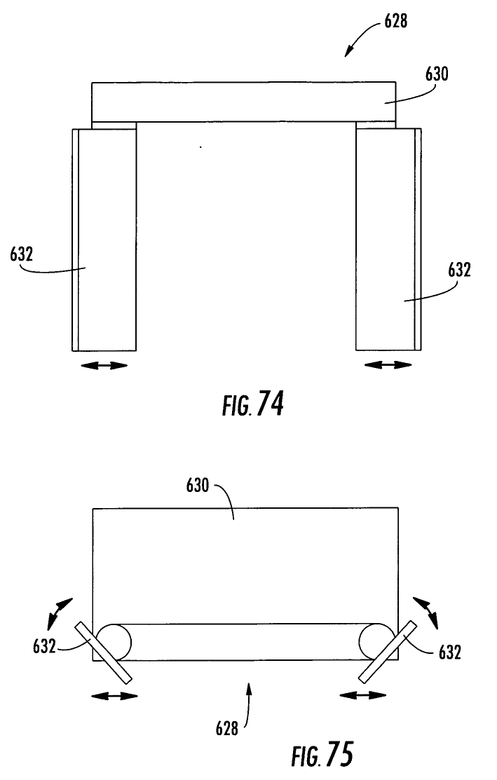

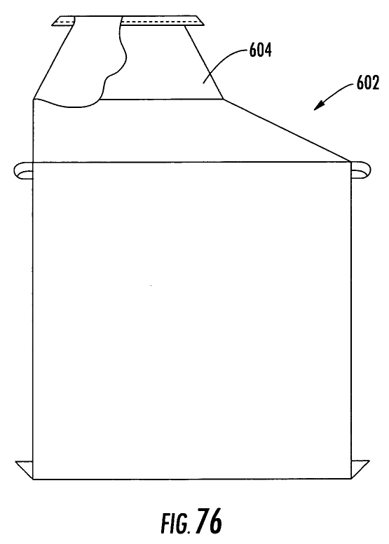

FIG. 73 illustrates a pair of the bulk bags 606 stacked on top of each other. The presence of the angled base panels 616 and angled corner panels 620 creates gaps 626 which make it easier to clamp and pick up the bulk bags 606 when they are stacked on top of each other or in a close side-by-side arrangement. These bulk bags 606, or the bulk bags 12 described above, may be easily clamped and picked up by a forklift (not shown) equipped with a turning fork clamp assembly 628, as shown in FIGS. 74 and 75. The turning fork clamp assembly 628 may be of a known type which is available from Allied System Company, Sherwood, Oreg., USA. It includes a frame 630 for being attached to a forklift, and a pair of hydraulically-powered tines 632 which can be selectively rotated and traversed in and out.

The foregoing has described a bulk bag handling and discharging apparatus and method. While specific embodiments of the present invention have been described, it will be apparent to those skilled in the art that various modifications thereto can be made without departing from the spirit and scope of the invention. In particular, once a bulk bag has been provided with an adapter assembly, the bulk bag may be handled in virtually any manner that a rigid container could be handled. Accordingly, the foregoing description of the preferred embodiment of the invention and the best mode for practicing the invention are provided for the purpose of illustration only and not for the purpose of limitation, the invention being defined by the claims.

1. An adapter assembly for being attached to a flexible bulk bag having a body and a spout with an opening for discharging bulk material therefrom, said adapter assembly comprising:
a rigid annular adapter ring including an annular, radially-outwardly extending flange adapted for being engaged by a surrounding clamp; and
means for supporting said spout of said bulk bag.

2. The adapter assembly of claim 1 wherein said support means comprise at least one arm attached to and extending away from said adapter ring, said arm adapted to engage said bulk bag.

3. The adapter assembly of claim 1 further comprising a discharge device adapted to be attached to said adapter ring.

4. The adapter assembly of claim 3 wherein said discharge device is a funnel valve having an inlet end for being attached to said flange and an outlet including a valve for stopping and starting a flow of material.

5. The adapter assembly of claim 3 wherein said discharge device is a cone valve, comprising:
a tapered funnel having an inlet end with a first diameter for being attached to said flange, and an outlet end having a second diameter smaller than said first diameter; and
a cone disposed in said funnel, the base of said cone facing said outlet end, said cone being movable between a closed position in which a peripheral edge thereof of said cone seals against said funnel, and an open position in which material may flow between said peripheral edge and said funnel.

6. The adapter assembly of claim 3 wherein said discharge device is a split butterfly valve, comprising:
a passive valve section including a passive valve disk movable between a closed position and an open position; and
an active valve section removable connected to said passive valve section, said active valve section including an active valve disk movable between a closed position and an open position, wherein said passive valve disk is locked into said closed position when said active valve section is disconnected from said passive valve section.

7. An apparatus for storing and discharging bulk material, comprising:
a flexible bulk bag for containing a flowable material, said bulk bag having a spout with an opening;
an adapter assembly attached to said bag, comprising:
a rigid annular adapter ring including an annular protruding flange; and
means for supporting said spout of said bulk bag; and
a discharge device attached to said adapter assembly for guiding material out of said bulk bag.

8. The adapter assembly of claim 7 wherein said support means comprise at least one arm extending away from said adapter ring, said arm adapted to engage said bulk bag.

9. The adapter assembly of claim 7 wherein said discharge device is a funnel valve having an inlet end for being attached to said flange and an outlet including a valve for stopping and starting a flow of material.

10. The adapter assembly of claim 7 wherein said discharge device is a cone valve, comprising:
a tapered funnel having an inlet end with a first diameter for being attached to said flange, and an outlet end having a second diameter smaller than said first diameter; and
a cone disposed in said funnel, the base of said cone facing said outlet end, said cone being movable between a closed position in which a peripheral edge thereof of said cone seals against said funnel, and an open position in which material may flow between said peripheral edge and said funnel.

11. The adapter assembly of claim 7 wherein said discharge device is a split butterfly valve, comprising:
a passive valve section including a passive valve disk movable between a closed position and an open position; and
an active valve section removable connected to said passive valve section, said active valve section including an active valve disk movable between a closed position and an open position, wherein said passive valve disk is locked into said closed position when said active valve section is disconnected from said passive valve section.

12. An apparatus for supporting a flexible bulk bag having a body and a spout with an opening for discharging bulk material therefrom, said apparatus comprising:
an adapter assembly for being attached to said bag, comprising:
a rigid annular adapter ring including an annular, radially-outwardly extending flange adapted for being engaged by a surrounding clamp; and
means for supporting said spout of said bulk bag; and
at least one support bracket adapted to be attached to said bulk bag and said adapter assembly, said support bracket cooperating with said adapter assembly to support said bulk bag in a tensioned condition.

13. The apparatus of claim 12 wherein said support bracket comprises a pair of spaced-apart vertical members bridged by a pair of generally C-shaped horizontally extending braces.

14. The apparatus of claim 13 wherein said support bracket includes at least one bag mount for receiving a mounting means carried by said bulk bag.

15. The apparatus of claim 14 wherein said bag mount is a cleat having a pair of pivoted jaws.

16. The apparatus of claim 12 wherein said adapter assembly and said support bracket include complementary alignment features for maintaining said adapter assembly in a fixed position relative to said support bracket.

17. A method for discharging material from a bulk bag having a spout with an outlet, comprising the steps of:
disposing said bag with said spout facing upwards;
attaching an adapter assembly to said bulk bag, said adapter assembly supporting said outlet in a rigid open shape;
attaching a discharge device to said outlet;
inverting said bulk bag; and
allowing material to flow from said bulk bag through said outlet and said discharge device.

18. The method of claim 17, wherein said adapter assembly comprises:
a rigid annular adapter ring including an annular, radially-outwardly extending flange adapted for being engaged by a surrounding clamp; and
means for supporting said spout of said bulk bag in a tensioned condition.

19. The method of claim 18, wherein said step of placing said adapter assembly on said bulk bag comprises:
inserting the opening of said spout through said adapter ring;
folding the edge of said opening over said flange; and
clamping said edge of said bag against said flange.

20. The method of claim 17, wherein the step of allowing material to flow from said bulk bag through said outlet and said discharge device comprises selectively starting and stopping the flow of material through said discharge device.

21. The method of claim 20, wherein said discharge device is a funnel valve having an inlet end for being attached to said flange and an outlet including a valve for stopping and starting a flow of material.

22. The method of claim 20 wherein said discharge device is a cone valve, comprising:
a tapered funnel having an inlet end with a first diameter for being attached to said flange, and an outlet end having a second diameter smaller than said first diameter; and
a cone disposed in said funnel, the base of said cone facing said outlet end, said cone being movable between a closed position in which a peripheral edge thereof of said cone seals against said funnel, and an open position in which material may flow between said peripheral edge and said funnel.

23. The method of claim 20 wherein said discharge device is a split butterfly valve, comprising:
a passive valve section including a passive valve disk movable between a closed position and an open position; and
an active valve section removable connected to said passive valve section, said active valve section including an active valve disk movable between a closed position and an open position, wherein said passive valve disk is locked into said closed position when said active valve section is disconnected from said passive valve section.

24. The method of claim 17 further comprising, subsequent to the step of attaching an adapter assembly to said bulk bag, attaching at least one support bracket to said bulk bag and to said adapter assembly such that said bulk bag is supported in a tensioned condition.

25. The method of claim 24 wherein the step of attaching a support bracket to said bulk bag and to said adapter assembly comprises positioning a pair of said support brackets on opposite sides of said bulk bag.

26. The method of claim 24 further comprising:
providing said bulk bag with mounting means;
providing said support bracket with at least one bag mount; and
attaching said mounting means to said bag mount.
